(19) United States
(12) Patent Application Publication
(10) Pub. No.: US 2008/0044200 A1
(43) Pub. Date: Feb. 21, 2008

(54) Method for Reattaching Layer Thickness Regulating Member, Developing Device, Image Forming Apparatus, Image Forming System and Method for Remanufacturing Developing Device

(75) Inventor: Katsumi OKAMOTO, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/571,887

(22) PCT Filed: Aug. 26, 2005
(86) PCT No.: PCT/JP05/15557

§ 371 Date: Jan. 9, 2007

(30) Foreign Application Priority Data
Aug. 27, 2004 (JP) 2004-248937
Aug. 8, 2005 (JP) 2005-229912
Aug. 8, 2005 (JP) 2005-229913

(51) Int. Cl. G03G 15/00

(52) U.S. Cl. 399/109

(57) ABSTRACT

A layer thickness regulating member is reattached to a developing device by a simple method. A method for reattaching a layer thickness regulating member has a step of removing the layer thickness regulating member from a developing device provided with the layer thickness regulating member, for regulating a layer thickness of a developer borne on a developer bearing body, that contacts the developer bearing body at a contacting section, a step of adjusting a length of the layer thickness regulating member reattached to the developing device, based on information indicating the length from the front end of the layer thickness regulating member to the contacting section, which is an information that is stored in the developing device, and a step of reattaching the layer thickness regulating member for which the length is adjusted to the developing device.

### TECHNICAL FIELD

The present invention relates to methods for reattaching layer thickness regulating members, developing devices, image forming apparatuses, image forming systems and methods for remanufacturing developing devices.

### BACKGROUND ART

Image forming apparatuses such as laser beam printers are already well known. Such image forming apparatuses include, for example, a photoconductor for bearing latent images and a developing device for developing latent images borne on the photoconductor with developers. When an image signal or the like is transmitted from an external apparatus such as a host computer, the image forming apparatus positions the developing device at the developing position opposing the photoconductor, forms a developer image by developing a latent image borne on the photoconductor with a developer in the developing device, transfers the developer image onto a medium, and ultimately forms an image on the medium.

The above-described developing device includes a developer bearing body for bearing developers, a layer thickness regulating member that contacts the developer bearing body at a contacting section so as to regulate the layer thickness of the developer borne on the developer bearing body and the like, in order to realize the aforesaid function, namely, developing latent images borne on the photoconductor or other similar functions. Such a developing apparatus develops latent images borne on the photoconductor with developers that are borne on a developing roller with their thickness regulated by the layer thickness regulating member (See JP-A-2003-270934).

### DISCLOSURE OF INVENTION

Incidentally, developing devices are generally recycled (reused) from the viewpoint of resource saving, environmental protection, cost reduction or the like. When a developer in a developing device runs out as the developing device is used, the developing device is collected by a supplier or the like of the same. The supplier or the like refills the developing device with a developer to remanufacture the same.

In such a case, the layer thickness regulating member is sometimes replaced along with refilling with a developer. With respect to the layer thickness regulating member, the contacting member that contacts the developer bearing body wears as the developing device is used, and therefore the layer thickness regulating member is replaced as necessary after checking the wear condition thereof. Specifically, if a layer thickness regulating member is worn to a significant degree, that worn layer thickness regulating member is removed and a new layer thickness regulating member is reattached.

Taking into account the fact that when a developing device is manufactured as a new developing device (i.e., not as a recycled developing device) a layer thickness regulating member is attached to a developing device once, there has been a demand for a further simplified method for attaching the layer thickness regulating member when reattaching the same.

The present invention has been devised in consideration of these issues, and it is an object thereof to reattach the layer thickness regulating member to the developing device in a simple method.

A primary aspect of the present invention is a method for reattaching a layer thickness regulating member including a step of removing the layer thickness regulating member from a developing device provided with the layer thickness regulating member for regulating a layer thickness of a developer borne on a developer bearing body, that contacts the developer bearing body at a contacting section; a step of adjusting a length, of the layer thickness regulating member to be reattached to the developing device, from a front end of the layer thickness regulating member to the contacting section, based on information that is stored in the developing device and indicates the length; and a step of reattaching the layer thickness regulating member for which the length is adjusted to the developing device.

The developing device is shipped after assembled, in other words, after the developer bearing body, the layer thickness regulating member and the like are attached to the developing device. In some cases, data indicating characteristic of the developer that has passed between the contacting section and the developer bearing body is obtained by actual measurement prior to the shipment (and also after the developer bearing body, the layer thickness regulating member and the like are attached to the developing device).

For example, at the first rotation of the developer bearing body after the developing device is assembled, the developer tends to leak from between the contacting section and the developer bearing body. Therefore, a process in which the developer bearing body is rotated until the developer ceases leaking is generally carried out prior to shipment of the developing device (before a purchaser obtains the developing device). When carrying out the process, data indicating the developer leakage degree can be obtained as the data by actually measuring the time required until the developer ceases leaking, etc. (it should be noted that if it is found through the process that a subject developing device shows an excessive leakage of the developer and fails to satisfy the specification relating to the developer leakage degree, such a developing device may not be shipped).

The above-described characteristic of the developer that has passed between the contacting section and the developer bearing body vary among developing devices. For example, if such a characteristic of a developer refers to the developer leakage degree, among developing devices that have satisfied the specification for the developer leakage degree during the process and are to be shipped, there are some developing devices that are favorable in terms of the characteristic (in other words, there is little leakage), and there are others that are unfavorable in terms of the characteristic (in other words, there is much leakage).

Incidentally, developing devices are generally reused from the viewpoint of resource saving, environmental protection, cost reduction, or the like. When a developer in a developing device runs out as the developing device is used, the developing device is collected by a supplier or the like of the same. The supplier or the like refills the developing device with a developer to remanufacture the same.

When remanufacturing the developing device, it is desirable that the developing device that is unfavorable in terms of the characteristic is remanufactured as the developing device that is favorable in terms of the characteristic.

The present invention has been devised in consideration of these issues, and it is an object thereof to improve performance of the developing device when remanufacturing the same.

Another primary aspect of the present invention is a method for remanufacturing a developing device, including a step of refilling with a developer a developing device provided with a developer bearing body for bearing a developer and a layer thickness regulating member, for regulating a layer thickness of a developer borne on the developer bearing body, that contacts the developer bearing body at a contacting section, and a step of determining whether or not to modify a relative position of the layer thickness regulating member with respect to the developer bearing body, based on data that is actually measured after the developer bearing body and the layer thickness regulating member are attached to the developing device and stored in the developing device, and indicates a characteristic of a developer that has passed between the contacting section and the developer bearing body; and modifying the relative position when it is determined to modify the relative position.

It is known that whether the characteristic of the developer in the developing device (transportability or chargeability of developer, for example) is favorable or unfavorable depends on the relative position of the layer thickness regulating member with respect to the developer bearing body, the surface roughness of the developer bearing body, the type (lot) of the developer that fills the developing device or the like.

Accordingly, when a developing device is manufactured, in some cases the above three parameters are selected so as to make the characteristic favorable. For example, a plurality of choices are provided respectively as choices for the relative position that is adjusted, as choices for the surface roughness of the developer bearing body that is attached to the developing device, and as choices for the developer that fills the developing device. One choice is selected from each of the choice groups to select a combination of choices that makes the characteristic favorable.

Incidentally, developing devices are generally reused from the viewpoint of resource saving, environmental protection, cost reduction or the like. When a developer in a developing device runs out as the developing device is used, the developing device is collected by a supplier or the like of the same. The supplier or the like refills the developing device with a developer to remanufacture the same.

Also in such a case, the surface roughness of the developer bearing body provided in the remanufactured developing device can be different from the surface roughness of the developer bearing body of the developing device when manufactured as a new developing device (i.e., not as a reused developing device). For example, such an occasion may occur when the developer bearing body is replaced in remanufacturing the developing device due to significant wear of the developer bearing body. Also, the type (lot) of the developer for refilling the developing device can be different from the type (lot) of the developer that has filled the developing device when the developing device was manufactured as a new developing device.

In such an occasion, while it is necessary to reselect a combination that makes the characteristic favorable, selecting such a combination from the beginning makes the procedures for remanufacturing the developing device complicated.

The present invention has been devised in consideration of these issues, and it is an object thereof to simplify the procedures for remanufacturing the developing device.

Yet another primary aspect of the present invention is a method for remanufacturing a developing device including a step of refilling with a developer a developing device provided with a developer bearing body for bearing a developer, and a layer thickness regulating member, for regulating a layer thickness of a developer borne on the developer bearing body, that contacts the developer bearing body at a contacting section, and in which surface roughness information indicating surface roughness of the developer bearing body is stored; a step of obtaining a surface roughness value of the developer bearing body provided in the developing device when refilling with a developer; and a step of modifying a relative position of the layer thickness regulating member with respect to the developer bearing body, based on the value obtained and the surface roughness information.

Other features of the present invention will become clear by reading the description of the present specification with reference to the accompanying drawings.

### BRIEF DESCRIPTION OF DRAWINGS

FIG. 1 is a diagram showing major component elements constituting a printer 10.

FIG. 2 is a block diagram showing a control unit of the printer 10 of FIG. 1.

FIG. 3 is a conceptual diagram of a developing device.

FIG. 4 is a cross-sectional view showing major component elements of the developing device.

FIG. 5 is a perspective view of a regulating blade 560.

FIG. 6 is a perspective view of a holder 526.

FIG. 7 is a perspective view showing a state in which an upper seal member 520, the regulating blade 560, and a developing roller 510 are attached to the holder 526 in an assembled manner.

FIG. 8 is a perspective view showing a state in which the holder 526 is attached to a housing 540.

FIG. 9 is a flow chart according to the first embodiment showing a method for reattaching the regulating blade 560.

FIG. 10 is an explanatory diagram according to the first embodiment for describing a procedure for adjusting the attachment position of the regulating blade 560.

FIG. 11 is a flow chart according to the second embodiment showing the first working example of the method for remanufacturing a yellow developing device 54.

FIG. 12 is an explanatory diagram according to the second embodiment for describing the method for adjusting the attachment position of the regulating blade 560.

FIG. 13 is a diagram according to the second embodiment showing four levels of the relative position.

FIG. 14 is a flow chart according to the second embodiment showing the second working example of the method for remanufacturing the yellow developing device 54.

FIG. 15 is a diagram according to the second embodiment showing four levels of the developing roller 510.

FIG. 16 is a flow chart according to the second embodiment showing the third working example of the method for remanufacturing the yellow developing device 54.

FIG. 17 is a diagram according to the second embodiment showing four levels of a toner.

FIG. 18 is a flow chart according to the third embodiment showing the first working example of the method for remanufacturing the yellow developing device 54.

FIG. 19 is an explanatory diagram according to the third embodiment for describing the method for adjusting the attachment position of the regulating blade 560.

FIG. 20 is a diagram according to the third embodiment showing four levels of the developing roller 510.

FIG. 21 is a diagram according to the third embodiment showing four levels of the relative position.

FIG. 22 is a flow chart according to the third embodiment showing the second working example of the method for remanufacturing the yellow developing device 54.

FIG. 23 is a diagram according to the third embodiment showing four levels of the toner.

FIG. 24 is a flow chart according to the third embodiment showing the third working example of the method for remanufacturing the yellow developing device 54.

FIG. 25 is a flow chart according to the third embodiment showing the fourth working example of the method for remanufacturing the yellow developing device 54.

FIG. 26 is an explanatory diagram describing an external configuration of an image forming system.

FIG. 27 is a block diagram showing a configuration of the image forming system shown in FIG. 26.

### EXPLANATION OF REFERENCE NUMERALS

10 laser beam printer
20 photoconductor
30 charging unit
40 exposure unit
50 YMCK developing unit
50a central shaft
51 black developing device
51a developing device-side memory
52 magenta developing device
52a developing device-side memory
53 cyan developing device
53a developing device-side memory
54 yellow developing device
54a developing device-side memory
55a, 55b, 55c and 55d holding section
60 first transferring unit
70 intermediate transferring body
75 cleaning unit
76 cleaning blade
80 second transferring unit
90 fixing unit
92 paper-supply tray
94 paper-supply roller
95 display unit
96 register roller
100 control unit
101 main controller
102 unit controller
112 interface
113 image memory
120 CPU
121 serial interface
122 main unit-side memory
510 developing roller
510a shaft section
510b large diameter section
510c shaft direction end portion
520 upper seal member
520a short side direction end portion
520b contacting surface
520c opposite surface
524 upper seal biasing member
526 holder
526a upper seal supporting section
526b developing roller supporting section
526c regulating blade supporting section
530 toner container
530a first toner containing section
530b second toner containing section
540 housing
542 upper housing section
544 lower housing section
545 partitioning wall
546 housing seal
550 toner supply roller
560 regulating blade
560a front end
562 rubber section
562a contacting section
564 rubber supporting section
564a thin plate
564b thin plate supporting section
564c long side direction end portions
564d short side direction one end portion
564e short side direction other end portion
570 spacer
572 aperture
574 end portion seal
576 shaft bearing
700 image forming system
702 computer
704 display device
706 printer
708 input device
708A keyboard
708B mouse
710 reading device
710A flexible disk drive unit
710B CD-ROM drive unit
802 internal memory
804 hard disk drive unit
T toner

### BEST MODE FOR CARRYING OUT THE INVENTION

At least the following matters will be made clear by the explanation in the present specification and the description of the accompanying drawings.

A method for reattaching a layer thickness regulating member including:

a step of removing the layer thickness regulating member from a developing device provided with the layer thickness regulating member for regulating a layer thickness of a developer borne on a developer bearing body, that contacts the developer bearing body at a contacting section;

a step of adjusting a length, of the layer thickness regulating member to be reattached to the developing device, from a front end of the layer thickness regulating member to the contacting section, based on information that is stored in the developing device and indicates the length; and

a step of reattaching the layer thickness regulating member for which the length is adjusted to the developing device.

With such a method for reattaching the layer thickness regulating member, it is possible to reattach the layer thickness regulating member to the developing device with a simpler method.

It is possible that the layer thickness regulating member includes a contacting member that contacts the developer bearing body and a supporting member for supporting at its one end portion the contacting member, wherein the method includes a step of adjusting a distance of the layer thickness regulating member to be reattached to the developing device from a reference position to the other end portion of the supporting member in a direction from the contacting member toward the developer bearing body, based on information that is stored in the developing device and indicates the distance, and wherein in the step of reattaching the layer thickness regulating member to the developing device, the layer thickness regulating member for which the distance and the length are adjusted is reattached to the developing device.

With such a method for reattaching the layer thickness regulating member, it is possible to reattach the layer thickness regulating member to the developing device with a further simpler method.

It is possible that in the step of adjusting the distance, the distance of the layer thickness regulating member reattached to the developing device is adjusted, based on information that is stored in the developing device and indicates a thickness of the contacting member.

With such a method for reattaching the layer thickness regulating member, it is possible to reattach the layer thickness regulating member to the developing device with a further simpler method.

It is possible that the information is stored in a storage element provided to the developing device.

Such a method is more preferable in terms of avoiding soiling of the developing device.

A method for reattaching a layer thickness regulating member including:

a step of removing the layer thickness regulating member from a developing device provided with the layer thickness regulating member for regulating a layer thickness of a developer borne on a developer bearing body, that contacts the developer bearing body at a contacting section;

a step of adjusting a length, of the layer thickness regulating member to be reattached to the developing device, from a front end of the layer thickness regulating member to the contacting section, based on information that is stored in the developing device and indicates the length;

a step of reattaching the layer thickness regulating member for which the length is adjusted to the developing device; and

a step of adjusting a distance of the layer thickness regulating member to be reattached to the developing device from a reference position to the other end portion of a supporting member provided in the layer thickness regulating member for supporting at its one end portion a contacting member, in a direction from the contacting member that is provided in the layer thickness regulating member and contacts the developer bearing body toward the developer bearing body, based on information that is stored in the developing device and indicates the distance,

wherein in the step of reattaching the layer thickness regulating member to the developing device, the layer thickness regulating member for which the distance and the length are adjusted is reattached to the developing device,

in the step of adjusting the distance, the distance of the layer thickness regulating member reattached to the developing device is adjusted, based on information that is stored in the developing device and indicates a thickness of the contacting member, and

the information is stored in a storage element provided to the developing device.

With such a method, all of the described effects can be achieved and the object of the present invention is more effectively achieved.

A developing device including:

a developer bearing body for bearing a developer;

a layer thickness regulating member, for regulating a layer thickness of a developer borne on the developer bearing body, that contacts the developer bearing body at a contacting section; and

information that indicates a length from a front end of the layer thickness regulating member to the contacting section.

With such a developing device, it is possible to reattach the layer thickness regulating member to the developing device with a simpler method.

It is possible that the layer thickness regulating member includes a contacting member that contacts the developer bearing body and a supporting member for supporting at its one end portion the contacting member, and

the developing device has information that indicates a distance from a reference position to the other end portion of the supporting member in a direction from the contacting member toward the developer bearing body.

With such a developing device, it is possible to reattach the layer thickness regulating member to the developing device with a further simpler method.

It is possible to include information that indicates a thickness of the contacting member.

With such a developing device, it is possible to reattach the layer thickness regulating member to the developing device with a further simpler method.

It is possible that the information is stored in a storage element provided to the developing device.

Such a developing device is more preferable in terms of avoiding soiling of the developing device.

A developing device including:

a developer bearing body for bearing a developer;

a layer thickness regulating member, for regulating a layer thickness of a developer borne on the developer bearing body, that contacts the developer bearing body at a contacting section;

information that indicates a length from a front end of the layer thickness regulating member to the contacting section;

information that indicates a distance from a reference position to the other end portion of a supporting member provided in the layer thickness regulating member for supporting at its one end portion a contacting member, in a direction from the contacting member that is provided in the layer thickness regulating member and contacts the developer bearing body toward the developer bearing body; and

information that indicates a thickness of the contacting member,

wherein the information is stored in a storage element provided to the developing device.

With such a developing device, all of the described effects can be achieved and the object of the present invention is more effectively achieved.

An image forming apparatus including:

a developing device including a developer bearing body for bearing a developer, a layer thickness regulating member, for regulating a layer thickness of a developer borne on the developer bearing body, that contacts the developer bearing body at a contacting section, and information that indicates a length from a front end of the layer thickness regulating member to the contacting section.

In such an image forming apparatus, it is possible to reattach the layer thickness regulating member to the developing device provided in the image forming apparatus in a simpler method.

An image forming system including:

a computer; and

an image forming apparatus that can be connected to the computer, the image forming apparatus including a developing device that has a developer bearing body for bearing a developer, a layer thickness regulating member, for regulating a layer thickness of a developer borne on the developer bearing body, that contacts the developer bearing body at a contacting section, and information that indicates a length from a front end of the layer thickness regulating member to the contacting section.

With such an image forming system, it is possible to reattach the layer thickness regulating member to the developing device provided in the image forming system in a simpler method.

A method for remanufacturing a developing device, including:

a step of refilling with a developer a developing device provided with a developer bearing body for bearing a developer and a layer thickness regulating member, for regulating a layer thickness of a developer borne on the developer bearing body, that contacts the developer bearing body at a contacting section; and

a step of modifying a relative position when it is determined to modify the relative position, by determining whether or not to modify the relative position of the layer thickness regulating member with respect to the developer bearing body, based on data that is actually measured after the developer bearing body and the layer thickness regulating member are attached to the developing device and stored in the developing device, and indicates a characteristic of a developer that has passed between the contacting section and the developer bearing body.

With such a method for remanufacturing the developing device, it is possible to improve the performance of the developing device when remanufacturing the developing device.

It is possible that in the step of modifying the relative position, a modification extent of the relative position is changed based on the data.

With such a method for remanufacturing the developing device, it is possible to more suitably improve the performance of the developing device when remanufacturing the developing device.

It is possible that relative position information that indicates the relative position before the relative position is modified is stored in the developing device, and in the step of modifying the relative position, the relative position is modified using the relative position information.

With such a method for remanufacturing the developing device, procedures of the method for remanufacturing the developing device can be simplified.

It is possible that the relative position information is information that indicates a length from a front end of the layer thickness regulating member to the contacting section, and

in the step of modifying the relative position, the length is modified using the information indicating the length.

It is possible that the layer thickness regulating member includes a contacting member that contacts the developer bearing body and a supporting member for supporting at its one end portion the contacting member, the relative position information is information that indicates a distance from a reference position to the other end portion of the supporting member in a direction from the contacting member toward the developer bearing body, and in the step of modifying the relative position, the distance is modified using the information indicating the distance.

A method for remanufacturing a developing device including:

a step of refilling with a developer a developing device provided with a developer bearing body for bearing a developer and a layer thickness regulating member, for regulating a layer thickness of a developer borne on the developer bearing body, that contacts the developer bearing body at a contacting section; and

a step of replacing the developer bearing body with another developer bearing body when it is determined to replace the developer bearing body, by determining whether or not to replace the developer bearing body with the another developer bearing body, based on data that is actually measured after the developer bearing body and the layer thickness regulating member are attached to the developing device and stored in the developing device, and indicates a characteristic of a developer that has passed between the contacting section and the developer bearing body.

With such a method for remanufacturing the developing device, it is possible to improve the performance of the developing device when remanufacturing the developing device.

It is possible that in the step of replacing the developer bearing body with the another developer bearing body, the another developer bearing body is selected from among a plurality of developer bearing bodies that mutually have different surface roughness, based on the data.

With such a method for remanufacturing the developing device, it is possible to more suitably improve the performance of the developing device when remanufacturing the developing device.

It is possible that surface roughness information, that indicates surface roughness of a developer bearing body that has been provided in the developing device before replacement of the developer bearing body, and that is surface roughness when the developer bearing body has been attached to the developing device, is stored in the developing device, and in the step of replacing the developer bearing body with the another developer bearing body, the another developer bearing body is selected from among a plurality of developer bearing bodies that mutually have different surface roughness, using the surface roughness information.

With such a method for remanufacturing the developing device, procedures of the method for remanufacturing the developing device can be simplified.

A method for remanufacturing a developing device including:

a step of refilling with a developer a developing device provided with a developer bearing body for bearing a developer and a layer thickness regulating member, for regulating a layer thickness of a developer borne on the developer bearing body, that contacts the developer bearing body at a contacting section,

wherein in the step, a developer selected based on data, that is actually measured after the developer bearing body and the layer thickness regulating member are attached to the developing device and stored in the developing device, and indicates a characteristic of a developer that has passed between the contacting section and the developer bearing body, is used for refilling.

With such a method for remanufacturing the developing device, it is possible to improve the performance of the developing device when remanufacturing the developing device.

It is possible that developer information that specifies a developer that has filled the developing device before refilled with a developer is stored in the developing device, and in the step, a developer for refilling the developing device is selected using the developer information.

With such a method for remanufacturing the developing device, procedures of the method for remanufacturing the developing device can be simplified.

It is possible that the data is stored in a storage element provided to the developing device.

Such a method for remanufacturing the developing device is more preferable in terms of avoiding soiling of the developing device.

A method for remanufacturing a developing device, including:

a step of refilling with a developer a developing device provided with a developer bearing body for bearing a developer and a layer thickness regulating member, for regulating a layer thickness of a developer borne on the developer bearing body, that contacts the developer bearing body at a contacting section; and

a step of modifying the relative position when it is determined to modify the relative position, by determining whether or not to modify a relative position of the layer thickness regulating member with respect to the developer bearing body, based on data that is actually measured after the developer bearing body and the layer thickness regulating member are attached to the developing device and stored in the developing device, and indicates a characteristic of a developer that has passed between the contacting section and the developer bearing body,

wherein in the step of modifying the relative position,

a modification extent of the relative position is changed based on the data,

relative position information that indicates a relative position before the relative position is modified is stored in the developing device,

in the step of modifying the relative position,

the relative position is modified using the relative position information,

the relative position information is information that indicates a length from a front end of the layer thickness regulating member to the contacting section,

in the step of modifying the relative position,

the length is modified using the information indicating the length,

the layer thickness regulating member includes a contacting member that contacts the developer bearing body and a supporting member for supporting at its one end portion the contacting member,

the relative position information is information that indicates a distance from a reference position to the other end portion of the supporting member in a direction from the contacting member toward the developer bearing body,

in the step of modifying the relative position,

the distance is modified using the information indicating the distance, and

the data is stored in a storage element provided to the developing device.

With such a method for remanufacturing the developing device, all of the described effects can be achieved and the object of the present invention is more effectively achieved.

A developing device including:

a developer bearing body for bearing a developer;

a layer thickness regulating member, for regulating a layer thickness of a developer borne on the developer bearing body, that contacts the developer bearing body at a contacting section; and

a storage element for storing data that is actually measured after the developer bearing body and the layer thickness regulating member are attached to the developing device, and indicates a characteristic of a developer that has passed between the contacting section and the developer bearing body.

With such a developing device, it is possible to improve the performance of the developing device when remanufacturing the developing device.

An image forming apparatus including:

a developing device including a developer bearing body for bearing a developer, a layer thickness regulating member, for regulating a layer thickness of a developer borne on the developer bearing body, that contacts the developer bearing body at a contacting section, and a storage element for storing data that is actually measured after the developer bearing body and the layer thickness regulating member are attached to the developing device, and indicates a characteristic of a developer that has passed between the contacting section and the developer bearing body.

With such an image forming apparatus, it is possible to improve the performance of the developing device when remanufacturing the developing device.

A method for remanufacturing a developing device including:

a step of refilling with a developer a developing device including a developer bearing body for bearing a developer and a layer thickness regulating member, for regulating a layer thickness of a developer borne on the developer bearing body, that contacts the developer bearing body at a contacting section, in which surface roughness information indicating surface roughness of the developer bearing body is stored;

a step of obtaining a surface roughness value of the developer bearing body provided in the developing device when refilling with a developer; and

a step of modifying a relative position of the layer thickness regulating member with respect to the developer bearing body, based on the value obtained and the surface roughness information.

With such a method for remanufacturing the developing device, procedures for remanufacturing the developing device can be simplified.

It is possible that in the step of obtaining the value, the surface roughness value is obtained by measuring surface roughness of the developer bearing body provided in the developing device when refilling with a developer.

With such a method for remanufacturing the developing device, precise surface roughness values can be obtained.

A method for remanufacturing a developing device including:

a step of refilling with a developer a developing device provided with a developer bearing body for bearing a developer and a layer thickness regulating member, for regulating a layer thickness of a developer borne on the developer bearing body, that contacts the developer bearing body at a contacting section, in which developer information that specifies the developer is stored;

a step of obtaining second developer information that specifies a developer used for refilling; and

a step of modifying a relative position of the layer thickness regulating member with respect to the developer bearing body, based on the developer information stored in the developing device and the second developer information obtained.

With such a method for remanufacturing the developing device, procedures for remanufacturing the developing device can be simplified.

It is possible that relative position information that indicates a relative position before the relative position is modified is stored in the developing device, and in the step of modifying the relative position, the relative position is modified using the relative position information.

With such a method for remanufacturing the developing device, procedures for remanufacturing the developing device can be further simplified.

It is possible that the relative position information is information that indicates a length from the front end of the layer thickness regulating member to the contacting section, and in the step of modifying the relative position, the length is modified using the information indicating the length.

It is possible that the layer thickness regulating member includes a contacting member that contacts the developer bearing body and a supporting member for supporting at its one end portion the contacting member, the relative position information is information that indicates a distance from a reference position to the other end portion of the supporting member in a direction from the contacting member toward the developer bearing body, and in the step of modifying the relative position, the distance is modified using the information indicating the distance.

A method for remanufacturing a developing device including:

a step of refilling with a developer a developing device provided with a developer bearing body for bearing a developer in which surface roughness information indicating surface roughness of the developer bearing body is stored; and

a step of obtaining a surface roughness value of the developer bearing body provided in the developing device when refilling with a developer,

wherein in the step of refilling with the developer, a developer selected based on the value obtained and the surface roughness information is used for refilling.

With such a method for remanufacturing the developing device, procedures for remanufacturing the developing device can be simplified.

It is possible that in the step of obtaining the value, the surface roughness value is obtained by measuring surface roughness of the developer bearing body provided in the developing device when refilling with a developer.

With such a method for remanufacturing the developing device, precise surface roughness values can be obtained.

It is possible that developer information that specifies a developer that has been filled in the developing device before being refilled with a developer is stored in the developing device, and in the step of refilling with the developer, the developer for refilling the developing device is selected using the developer information.

With such a method for remanufacturing the developing device, procedures for remanufacturing the developing device can be further simplified.

A method for remanufacturing a developing device including:

a step of refilling with a developer a developing device including a developer bearing body for bearing a developer in which developer information that specifies the developer is stored;

a step of obtaining second developer information that specifies a developer used for refilling; and

a step of replacing the developer bearing body with another developer bearing body selected from among a plurality of developer bearing bodies that mutually have different surface roughness based on the developer information stored in the developing device and the second developer information obtained.

With such a method for remanufacturing the developing device, procedures for remanufacturing the developing device can be simplified.

It is possible that surface roughness information that indicates surface roughness of a developer bearing body that has been provided in the developing device before replacement of the developer bearing body that is surface roughness when the developer bearing body has been attached to the developing device is stored in the developing device, and in the step of replacing the developer bearing body with the another developer bearing body, the another developer bearing body is selected from among a plurality of developer bearing bodies that mutually have different surface roughness using the surface roughness information.

With such a method for remanufacturing the developing device, procedures for remanufacturing the developing device can be further simplified.

A method for remanufacturing a developing device including:

a step of refilling with a developer a developing device including a developer bearing body for bearing a developer, a layer thickness regulating member, for regulating a layer thickness of a developer borne on the developer bearing body, that contacts the developer bearing body at a contacting section in which surface roughness information indicating surface roughness of the developer bearing body is stored;

a step of obtaining a surface roughness value of the developer bearing body provided in the developing device when refilling with a developer, and

a step of modifying a relative position of the layer thickness regulating member with respect to the developer bearing body, based on the value obtained and the surface roughness information,

wherein

in the step of obtaining the value,

the surface roughness value is obtained by measuring surface roughness of the developer bearing body provided in the developing device when refilling with a developer,

relative position information that indicates a relative position before the relative position is modified is stored in the developing device,

in the step of modifying the relative position,

the relative position is modified using the relative position information,

the relative position information is information that indicates a length from the front end of the layer thickness regulating member to the contacting section,

in the step of modifying the relative position,

the length is modified using the information indicating the length,

the layer thickness regulating member includes a contacting member that contacts the developer bearing body and a supporting member for supporting at its one end portion the contacting member,

the relative position information is information that indicates a distance from a reference position to the other end portion of the supporting member, in a direction from the contacting member toward the developer bearing body, and

in the step of modifying the relative position,

the distance is modified using the information indicating the distance.

With such a method for remanufacturing the developing device, all of the described effects can be achieved and the object of the present invention is more effectively achieved.

===Exemplary Overall Configuration of the Image Forming Apparatus===

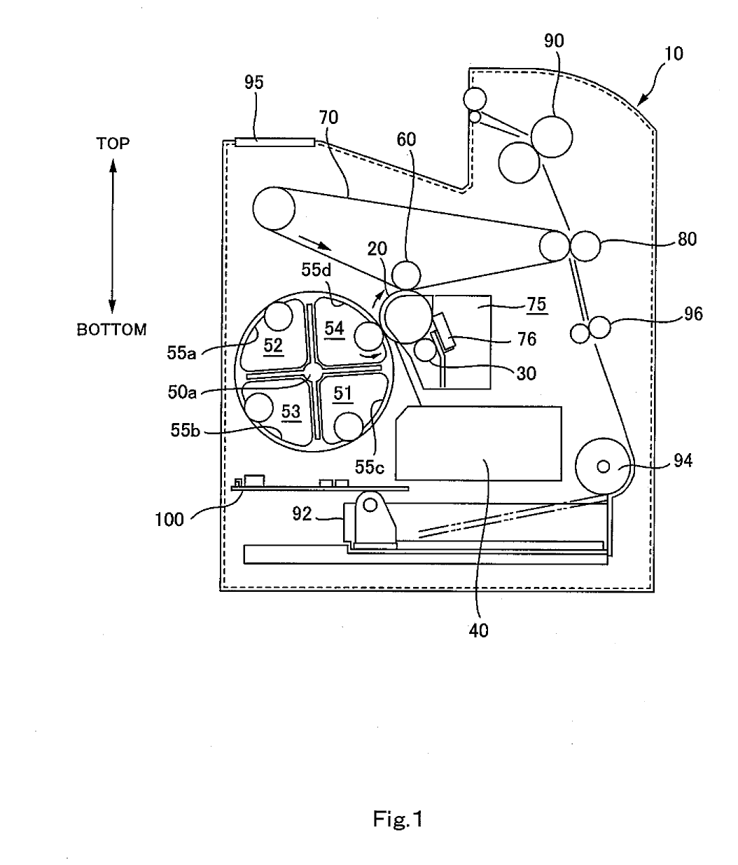

The outline of an image forming apparatus is explained using a laser beam printer 10 (hereinafter also referred to as a “printer”) as an example, with reference to FIG. 1. FIG. 1 is a diagram showing major component elements constituting the printer 10. It should be noted that the vertical direction of the printer 10 is indicated by arrows in FIG. 1. For example, a paper-supply tray 92 is disposed in a lower portion of the printer 10, and a fixing unit 90 is disposed in an upper portion of the printer 10.

The printer 10 of the present embodiment includes, as shown in FIG. 1, a charging unit 30, an exposure unit 40, a YMCK developing unit 50, a first transferring unit 60, an intermediate transferring body 70, and a cleaning unit 75 along the rotation direction of a photoconductor 20, and further includes a second transferring unit 80, the fixing unit 90, a display unit 95 that serves as notifying means to users and is made up of a liquid crystal panel and a control unit 100 that governs the operations as a printer by controlling these units, and the like.

The photoconductor 20 has a cylindrical conductive base and a photoconductive layer formed on the outer peripheral surface of the conductive base, and is rotatable about its central shaft. In the present embodiment, the photoconductor 20 rotates clockwise, as shown by the arrow in FIG. 1.

The charging unit 30 is a device for charging the photoconductor 20. The exposure unit 40 is a device for forming a latent image on the charged photoconductor 20 by irradiating a laser beam thereon. The exposure unit 40 has a semiconductor laser, a polygon mirror, an F-θ lens and the like, and irradiates a modulated laser beam onto the charged photoconductor 20 based on image signals input from a host computer (not shown) such as a personal computer, a word processor, or the like.

The YMCK developing unit 50 is a device for developing latent images formed on the photoconductor 20 using a toner T (in this specification, the toner T refers to a mixture of toner particles and various external additives) as an example of the developer contained in the developing device, namely, a black (K) toner contained in a black developing device 51, a magenta (M) toner contained in a magenta developing device 52, a cyan (C) toner contained in a cyan developing device 53, and a yellow (Y) toner contained in a yellow developing device 54.

The YMCK developing unit 50 rotates with the four developing devices 51, 52, 53, and 54 attached thereto, thereby making it possible to move the positions of the four developing devices 51, 52, 53, and 54. Specifically, the YMCK developing unit 50 holds the four developing devices 51, 52, 53, and 54 by four holding sections 55a, 55b, 55c, and 55d. The four developing devices 51, 52, 53, and 54 can be rotated about a central shaft 50a, while maintaining their relative positions. Every time image formation corresponding to one page is completed, the four developing devices 51, 52, 53 and 54 are selectively opposed to the photoconductor 20, and successively develop the latent image formed on the photoconductor 20, using the toners T contained in the developing devices 51, 52, 53, and 54. It should be noted that each of the four developing devices 51, 52, 53, and 54 can be attached to and removed from the holding sections of the YMCK developing unit 50. The developing devices are described later in detail.

The first transferring unit 60 is a device for transferring, onto the intermediate transferring body 70, a single-color toner image formed on the photoconductor 20. When toner images of four colors are successively transferred in a superposed manner, a full-color toner image is formed on the intermediate transferring body 70.

The intermediate transferring body 70 is an endless belt that is made by providing an aluminum-deposited layer on the surface of a PET film, and forming a layer of semiconductive coating on the layer surface thereof. The intermediate transferring body 70 is driven to rotate at substantially the same circumferential speed as the photoconductor 20.

The second transferring unit 80 is a device for transferring a single-color toner image or a full-color toner image formed on the intermediate transferring body 70 onto a medium such as paper, film, or cloth.

The fixing unit 90 is a device for fusing the single-color toner image or the full-color toner image, that has been transferred to the medium, onto the medium to turn it into a permanent image.

The cleaning unit 75 is a device that is provided between the first transferring unit 60 and the charging unit 30, has a rubber cleaning blade 76 that is made to contact with the surface of the photoconductor 20, and is for removing the toner T remaining on the photoconductor 20 by scraping it off with the cleaning blade 76 after the toner image has been transferred onto the intermediate transferring body 70 by the first transferring unit 60.

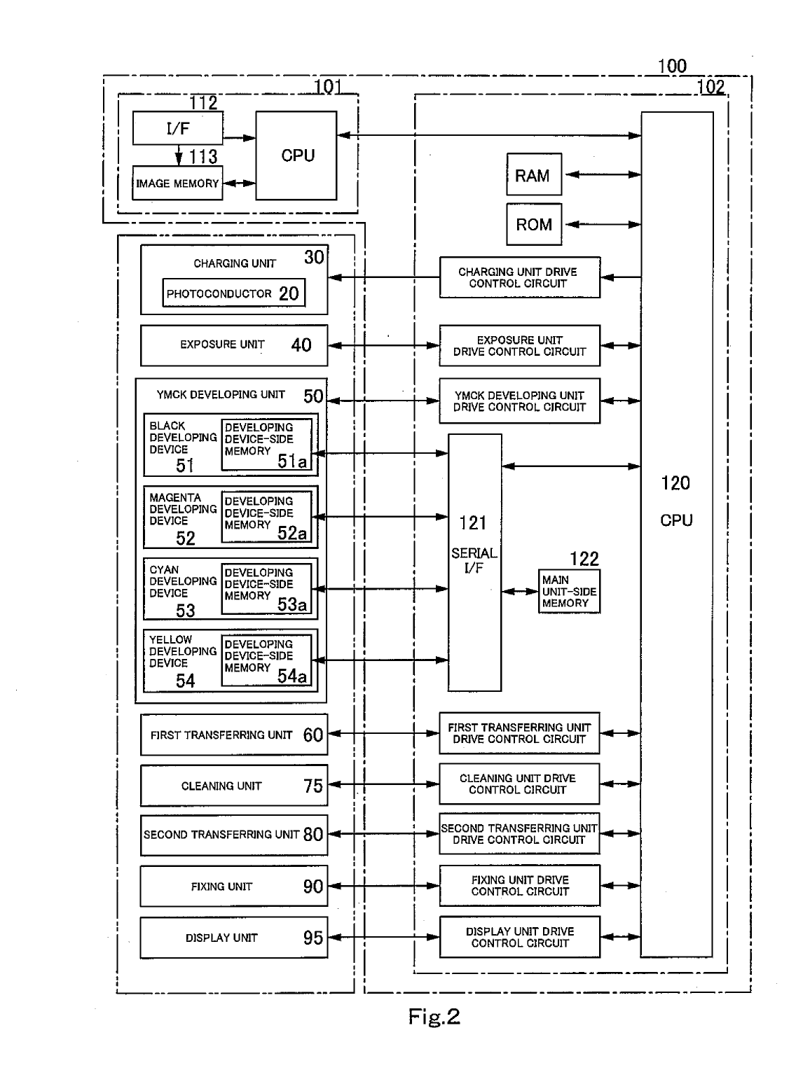

The control unit 100 is constituted by, as shown in FIG. 2, a main controller 101 and a unit controller 102. The main controller 101 receives as input image signals and control signals. According to instructions based on the image signals and control signals, the unit controller 102 forms images by controlling the various units, etc.

Next, the operation of the printer 10 with the above configuration is described.

When an image signal and a control signal from a host computer (not shown) are input to the main controller 101 of the printer 10 via an interface (I/F) 112, the photoconductor 20, the developing roller as an example of the developer bearing body, and the intermediate transferring body 70 rotate as controlled by the unit controller 102 based on the instructions from the main controller 101. While rotating, the photoconductor 20 is successively charged by the charging unit 30 at the charging position.

The charged area on the photoconductor 20 reaches the exposing position with the rotation of the photoconductor 20, and by the exposure unit 40, a latent image corresponding to image information of the first color (for example, yellow Y) is formed on the area. The YMCK developing unit 50 is in the developing position in which the yellow developing device 54 that contains a yellow (Y) toner opposes the photoconductor 20.

The latent image formed on the photoconductor 20 reaches the developing position with the rotation of the photoconductor 20, and is developed with the yellow toner by the yellow developing device 54. As a result, a yellow toner image is formed on the photoconductor 20.

With the rotation of the photoconductor 20, the yellow toner image formed on the photoconductor 20 reaches a first transferring position and is transferred onto the intermediate transferring body 70 by the first transferring unit 60. At this time, a first transfer voltage with a polarity that is opposite to the polarity for charging the toner T is applied to the first transferring unit 60. It should be noted that, during this period, the photoconductor 20 and the intermediate transferring body 70 are in contact, whereas the second transferring unit 80 is separated from the intermediate transferring body 70.

With the above-described process being carried out successively for the second, third and fourth colors with the respective developing devices, toner images in four colors corresponding to the image signals are transferred to the intermediate transferring body 70 in a superimposed manner. Thus, a full-color toner image is formed on the intermediate transferring body 70.

With the rotation of the intermediate transferring body 70, the full-color toner image formed on the intermediate transferring body 70 reaches a second transferring position, and is transferred onto a medium by the second transferring unit 80. It should be noted that the medium is carried from the paper-supply tray 92 to the second transferring unit 80 via a paper-supply roller 94 and a register roller 96. When the transferring operation is carried out, the second transferring unit 80 is pressed against the intermediary transferring body 70, and applied with a second transfer voltage.

The full-color toner image transferred onto the medium is heated and pressurized by the fixing unit 90 and fused to the medium.

Meanwhile, after the photoconductor 20 passes by the first transferring position, the toner T adhering to the surface of the photoconductor 20 is scraped off by the cleaning blade 76 that is supported by the cleaning unit 75, and the photoconductor 20 is prepared for charging for the next latent image to be formed. The scraped-off toner T is collected into a remaining-toner collector of the cleaning unit 75.

===Outline of the Control Unit===

Next, the configuration of the control unit 100 is described with reference to FIG. 2. The main controller 101 of the control unit 100 is electrically connected to a host computer via the interface 112, and provided with an image memory 113 for storing image signals received from the host computer. The unit controller 102 is electrically connected to each unit in the main unit of the apparatus (charging unit 30, exposure unit 40, YMCK developing unit 50, first transferring unit 60, cleaning unit 75, second transferring unit 80, fixing unit 90, and display unit 95), and controls the units based on the signals input from the main controller 101 while detecting the condition of each unit by receiving signals from sensors provided in the units.

A CPU 120 provided in the unit controller 102 is electrically connected to a non-volatile storage element such as an EEPROM (hereinafter referred to as a main unit-side memory 122) via a serial interface 121. In addition to the main unit-side memory 122, the CPU 120 is also electrically connected to developing device-side memories 51a, 52a, 53a, and 54a provided in the developing devices 51, 52, 53, and 54 that are described below, via the serial interface 121.

Accordingly, the main unit-side memory 122 and the developing device-side memories 51a, 52a, 53a and 54a are able to communicate with each other. That is, information stored in the main unit-side memory 122 can be transferred to the developing device-side memories 51a, 52a, 53a, and 54a, and information stored in the developing device-side memories 51a, 52a, 53a, and 54a can be transferred to the main unit-side memory 122.

It should be noted that the electrical connection between the developing device-side memories 51a, 52a, 53a, and 54a and the CPU 120 (serial interface 121) may be achieved by linking information transfer lines on the sides of the developing device and the main unit when the developing devices 51, 52, 53 and 54 are attached to the YMCK developing unit 50, or may be achieved wirelessly.

===Exemplary Configuration of the Developing Device===

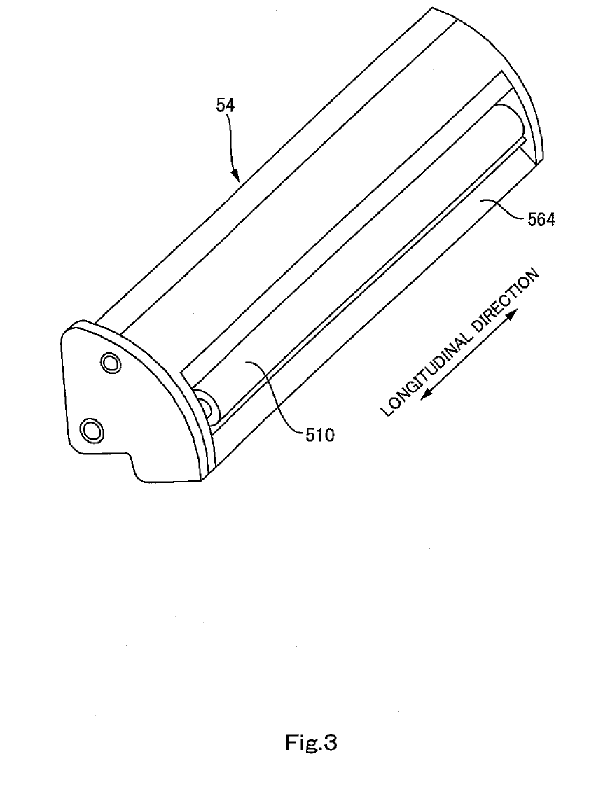

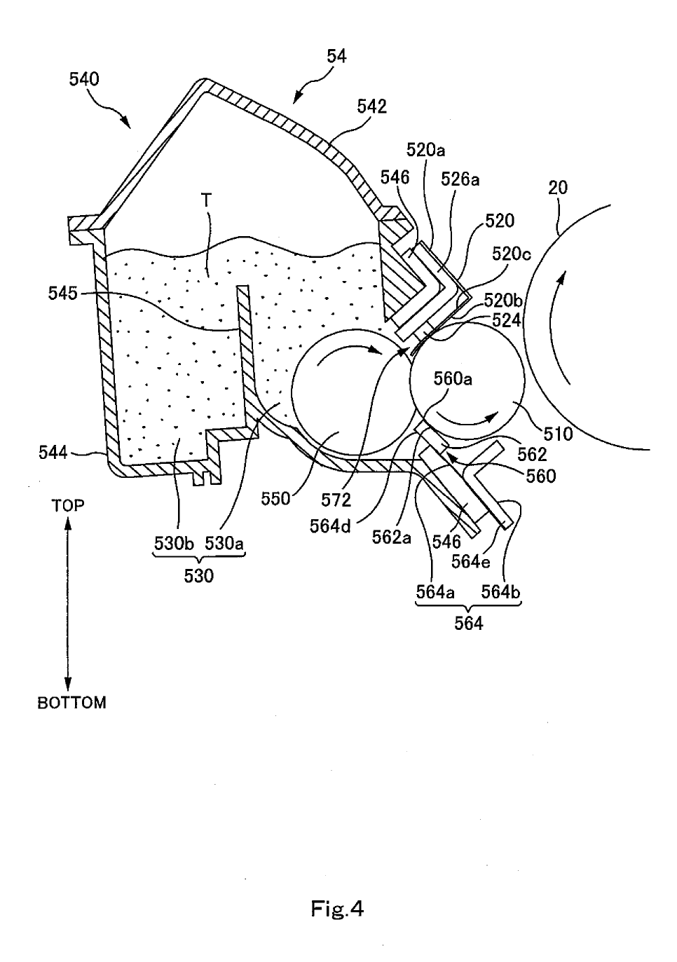

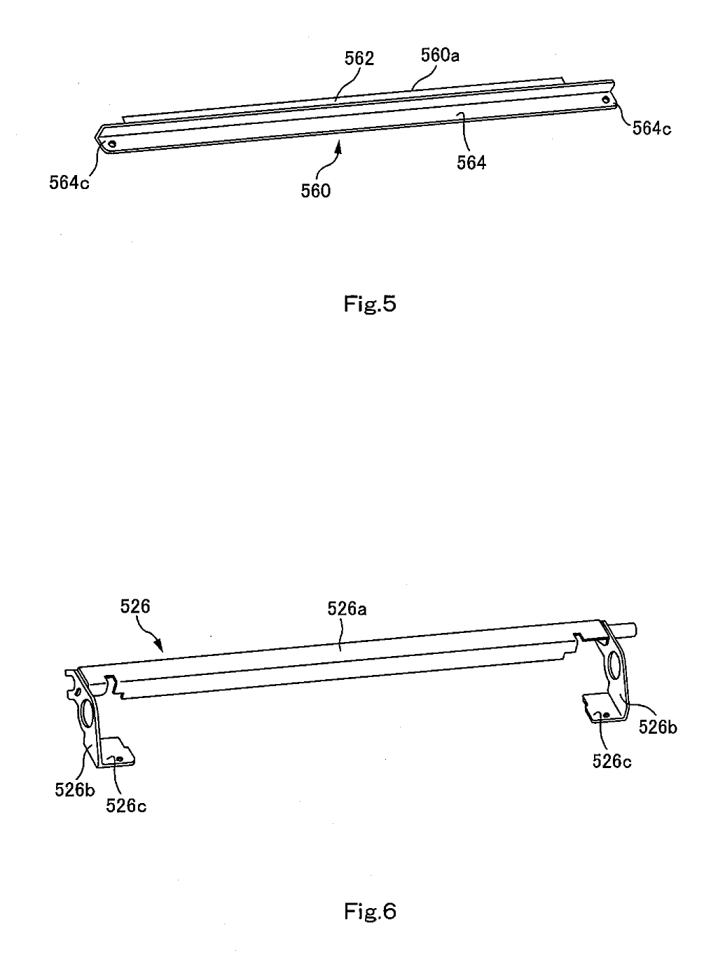

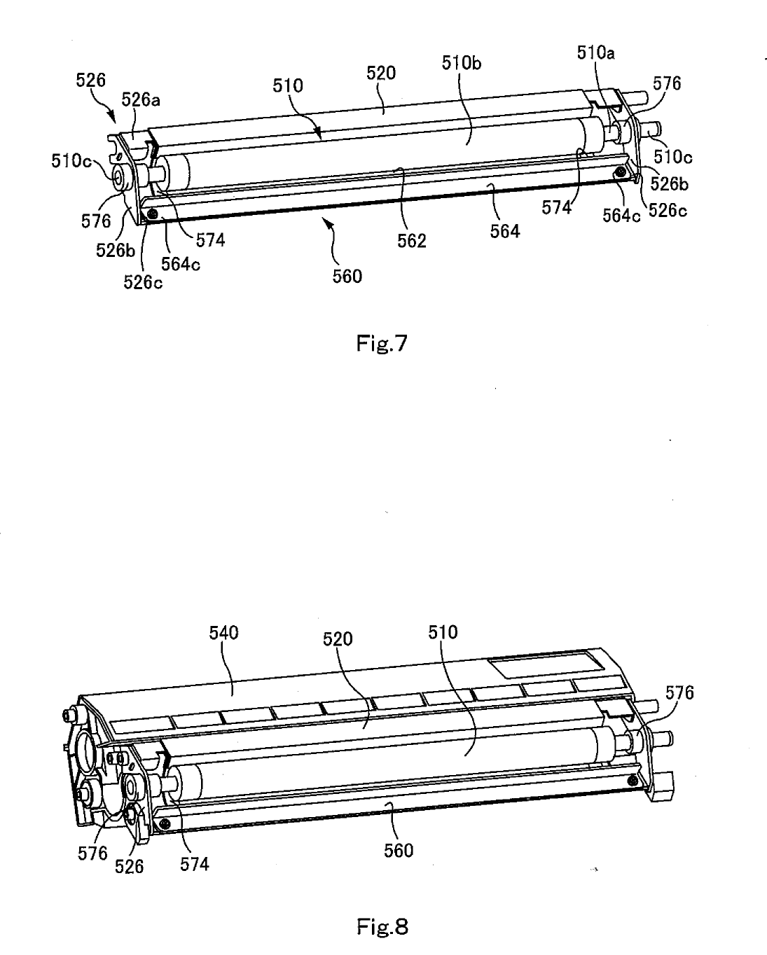

Next, an exemplary configuration of the developing device is described with reference to FIGS. 3 and 4. FIG. 3 is a conceptual diagram of the developing device. FIG. 4 is a cross-sectional view showing major component elements of the developing device. FIG. 5 is a perspective view of a regulating blade 560. FIG. 6 is a perspective view of a holder 526. FIG. 7 is a perspective view showing a state in which an upper seal member 520, the regulating blade 560 and a developing roller 510 are attached to the holder 526 in an assembled manner. FIG. 8 is a perspective view showing a state in which the holder 526 is attached to a housing 540. The cross-sectional view shown in FIG. 4 shows a cross section obtained by cutting the developing device by a plane perpendicular to the long side direction shown in FIG. 3. In FIG. 4, the vertical direction is indicated by arrows as in FIG. 1. For example, the central shaft of the developing roller 510 is located below the central shaft of the photoconductor 20. Also in FIG. 4, a state is described in which the yellow developing device 54 is located at the developing position opposing the photoconductor 20.

The YMCK developing unit 50 is provided with the black developing device 51 containing a black (K) toner, the magenta developing device 52 containing a magenta (M) toner, the cyan developing device 53 containing a cyan (C) toner, and the yellow developing device 54 containing a yellow (Y) toner. Since the developing devices have a similar configuration, the configuration of the yellow developing device 54 is described below.

The yellow developing device 54 includes the developing roller 510, the upper seal member 520, a toner container 530, the housing 540, a toner supply roller 550, the regulating blade 560 as an example of the layer thickness regulating member, the holder 526, the developing device-side memory 54a (FIG. 2), and the like.

The developing roller 510 bears the toner T and carries the same to the developing position opposing the photoconductor 20. The developing roller 510 is made up of aluminum alloy such as 5056 aluminum alloy or 6063 aluminum alloy, iron alloy such as STKM or the like, and plated with nickel, chrome or the like, as required.

The developing roller 510 has a shaft section 510a and a large diameter section 510b. The developing roller 510 is rotatably supported with the shaft section 510a being supported by a developing roller supporting section 526b of the holder 526 that is described below, via a shaft bearing 576 (FIG. 7). As shown in FIG. 4, the developing roller 510 rotates in a direction opposite (in FIG. 4, the counterclockwise direction) to the rotational direction of the photoconductor 20 (in FIG. 4, the clockwise direction). The central shaft of the developing roller 510 is disposed in a position lower than that of the central shaft of the photoconductor 20.

When the yellow developing device 54 opposes the photoconductor 20, a gap is present between the developing roller 510 and the photoconductor 20. That is, the yellow developing device 54 develops the latent image formed on the photoconductor 20 in a non-contacting state. It should be noted that when developing the latent image formed on the photoconductor 20, an alternating electric field is formed between the developing roller 510 and the photoconductor 20.

The housing 540 is manufactured by fusing together a plurality of integrally-molded resin housing sections, that is, an upper housing section 542 and a lower housing section 544. The toner container 530 for containing the toner T is formed inside the housing 540. The toner container 530 is divided by a partitioning wall 545 for partitioning the toner T, which protrudes inwards (in the vertical direction of FIG. 4) from the inner wall thereof, into two toner containing sections, namely, a first toner containing section 530a and a second toner containing section 530b. The first toner containing section 530a and the second toner containing section 530b are in communication at the top portion, and in the state shown in FIG. 4, the movement of the toner T is regulated by the partitioning wall 545. However, when the YMCK developing unit 50 rotates, the toner contained in the first toner containing section 530a and the second toner containing section 530b is temporarily collected on the side where the top sides are in communication in the developing position, and when the YMCK developing unit 50 returns to the state shown in FIG. 4, the toner is mixed and returned to the first toner containing section 530a and the second toner containing section 530b. That is to say, by rotating the YMCK developing unit 50, the toner T in the developing device is suitably stirred.

Therefore, in the present embodiment, the toner container 530 is not provided with a stirring member, but it is also possible to provide a stirring member for stirring the toner T contained in the toner container 530. Moreover, as shown in FIG. 4, the housing 540 (specifically, the first toner containing section 530a) has an aperture 572 at its lower portion, and the developing roller 510 is provided so as to be opposed to this aperture 572.

The toner supplying roller 550 is provided in the first toner containing section 530a described above and supplies the toner T contained in the first toner containing section 530a to the developing roller 510. The toner supplying roller 550 scrapes the toner remaining on the developing roller 510 after developing from the developing roller 510. The toner supplying roller 550 is made of polyurethane foam, for example, and is in contact with the developing roller 510 in a state of elastic deformation. The toner supplying roller 550 is disposed at a lower portion of the first toner containing section 530a, and the toner T contained in the first toner containing section 530a is supplied to the developing roller 510 by the toner supplying roller 550 at the lower portion of the first toner containing section 530a. The toner supplying roller 550 is rotatable about its central shaft. The central shaft of the toner supplying roller 550 is situated below the central shaft of rotation of the developing roller 510. Also, the toner supplying roller 550 rotates in a direction (in FIG. 4, the clockwise direction) that is opposite the direction of rotation of the developing roller 510 (in FIG. 4, the counterclockwise direction)

The upper seal member 520 allows movement of the toner T remaining on the developing roller 510 after passing the developing position to the inside of the housing 540 by contacting on the developing roller 510 along the shaft direction thereof, and regulates movement of the toner T inside the housing 540 to the outside of the housing 540. The upper seal member 520 is a seal made of, for example, polyethylene film. The upper seal member 520 is supported by an upper seal supporting section 526a of the holder 526 described below, with its long side direction arranged along the axial direction of the developing roller 510 (FIG. 7). It should be noted that the contacting position where the upper seal member 520 contacts the developing roller 510 is above the central shaft of the developing roller 510.

An upper seal biasing member 524 made of an elastic body such as moltplane is provided between the surface on the opposite side to the contacting surface 520b that contacts the developing roller 510 (such a surface is also referred to as the opposite surface 520c) and the upper seal supporting section 526a in a compressed state. The upper seal biasing member 524 biases the upper seal member 520 toward the developing roller 510 using its biasing power, thereby pressing the upper seal member 520 against the developing roller 510.

The regulating blade 560 regulates the thickness of the toner T borne on the developing roller 510, or applies electric charges to the toner T borne on the developing roller 510 by contacting on the developing roller 510 along the axial direction thereof at the contacting section 562a. The regulating blade 560 includes, as shown in FIGS. 4 and 5, a rubber section 562 as an example of the contacting member, and a rubber supporting section 564 as an example of the supporting member.

The rubber section 562 is made up of silicon rubber, urethane rubber or the like, and is made to contact with the developing roller 510.

The rubber supporting section 564 is constituted by a thin plate 564a and a thin plate supporting section 564b, and supports the rubber section 562 at one end portion 564d in a short side direction (namely, the end portion on the side of the thin plate 564a). The thin plate 564a is made up of phosphor bronze, stainless steel or the like, and possesses spring properties. The thin plate 564a supports the rubber section 562 and uses its biasing force to press the rubber section 562 against the developing roller 510. The thin plate supporting section 564b is a metal steel plate disposed at the other end portion 564e in the short side direction of the rubber supporting section 564, and is attached to the thin plate 564a with supporting the thin plate 564a at the side end opposite to the side where the rubber section 562 is supported.

The regulating blade 560 is attached to a regulating blade supporting section 526c in a state in which the end portions 564c in the long side direction of the thin plate supporting section 564b are supported by the regulating blade supporting sections 526c of the holder 526 described below.

The end of the regulating blade 560 on the opposite side to the thin plate supporting section 564b, that is, a front end 560a, does not contact the developing roller 510, and a portion distant from the front end 560a by a predetermined distance (namely, the contacting section 562a) contacts the developing roller 510 for a certain width. Specifically, the regulating blade 560 does not contact the developing roller 510 at its edge but rather at its mid section. Also, the regulating blade 560 is disposed such that its front end 560a faces the upstream side in the direction in which the developing roller 510 rotates, and it is in so-called counter contact. It should be noted that the contacting position where the regulating blade 560 contacts the developing roller 510 is lower than the central shaft of the developing roller 510, and is lower than the central shaft of the toner supply roller 550. The regulating blade 560 contacts the developing roller 510 along the shaft direction thereof, thereby performing a function of preventing the leakage of the toner T from the toner container 530.

On the outer sides in the long side direction of the rubber section 562 of the regulating blade 560, an end portion seal 574 is provided (FIG. 7). The end portion seal 574 is made up of nonwoven fabric, and contacts the developing roller 510 along the circumferential direction thereof at the end portions in the shaft direction of the developing roller 510 so as to perform a function of preventing the leakage of the toner T from between the circumferential surface of the developing roller 510 and the housing 540.

The holder 526 is a metal member to which various members such as the developing roller 510 are attached in an assembled manner. As shown in FIG. 6, the holder 526 includes the upper seal supporting section 526a arranged along the long side direction of the holder 526 (that is, the shaft direction of the developing roller 510), the developing roller supporting sections 526b that are provided on the outer sides of the upper seal supporting section 526a in the long side direction (the shaft direction) and intersect the long side direction (the shaft direction), and the regulating blade supporting members 526c that intersect the developing roller supporting sections and opposes the long side direction end portions of the upper seal supporting section 526a.

As shown in FIG. 7, the upper seal member 520 is supported by the upper seal supporting section 526a at the short side direction end portion 520a (FIG. 4). The developing roller 510 is supported by the developing roller supporting sections 526b at the shaft direction end portions 510c.

Further, the regulating blade 560 is supported by the regulating blade supporting sections 526c at long side direction end portions 564c. The regulating blade 560 is attached to the regulating blade supporting sections 526c with screws, thereby fixed to the holder 526. It should be noticed that for the purpose of the positional arrangement of the regulating blade 560 with respect to the holder 526, one or a plurality of spacers 570 (FIG. 10) are provided between the long side direction end portions 564c and the regulating blade supporting sections 526c, as required.

In this way, as shown in FIG. 8, the holder 526 to which the upper seal member 520, the developing roller 510 and the regulating blade 560 are attached in an assembled manner is attached to the above-described housing 540 via a housing seal 546 (FIG. 4) for preventing the leakage of the toner T from between the holder 526 and the housing 540.

In the yellow developing device 54 with such a configuration, the toner supplying roller 550 supplies the toner T contained in the toner container 530 to the developing roller 510. The toner T that is supplied to the developing roller 510 is brought to the contacting position of the regulating blade 560 due to the rotation of the developing roller 510, and when the toner T passes the contacting position, the toner T is charged with its layer thickness regulated. The charged toner T on the developing roller 510, whose layer thickness has been regulated, is brought to the developing position in opposition to the photoconductor 20 due to further rotation of the developing roller 510, and is used for developing latent images formed on the photoconductor 20 in an alternating electric field at the developing position. The toner T on the developing roller 510 that has passed the developing position due to further rotation of the developing roller 510 passes the upper seal member 520 and is collected inside the developing device without being scraped off by the upper seal member 520. Moreover, the toner T that is still remaining on the developing roller 510 can be peeled off by the toner supplying roller 550.

It should be noted that the yellow developing device 54 is further provided with the above-described developing device-side memory 54a (FIG. 2). The developing device-side memory 54a is a non-volatile storage element such as an EEPROM capable of storing various types of information. The developing device-side memory 54a has a storing area for storing various types of information. In the developing device-side memory 54a of the present embodiment, ID information, information on manufacturing date, destination, manufacturing line, acceptable equipment, remaining toner amount, data indicating the toner leakage degree described below, regulating blade related information as an example of the relative position information described below, surface roughness information described below, toner information as an example of the developer information described below etc., of the yellow developing device 54 are stored in the storing area as such information.

### FIRST EMBODIMENT

### Method for Reattaching the Regulating Blade 560

As described in the section of “Disclosure of Invention”, developing devices are generally reused from the viewpoint of resource saving, environmental protection, cost reduction or the like. When a toner in a developing device runs out as the developing device is used, the developing device is collected by a supplier or the like of the same. The supplier or the like refills the developing device with a toner to remanufacture the same.

In such an occasion, the regulating blade is sometimes replaced along with refill with the toner. With respect to the regulating blade, the above-described rubber section wears as the developing device is used, and therefore the regulating blade is replaced as necessary after checking the wear condition thereof. Specifically, if a regulating blade is worn to a significant degree, that worn regulating blade is removed and a new regulating blade is reattached.

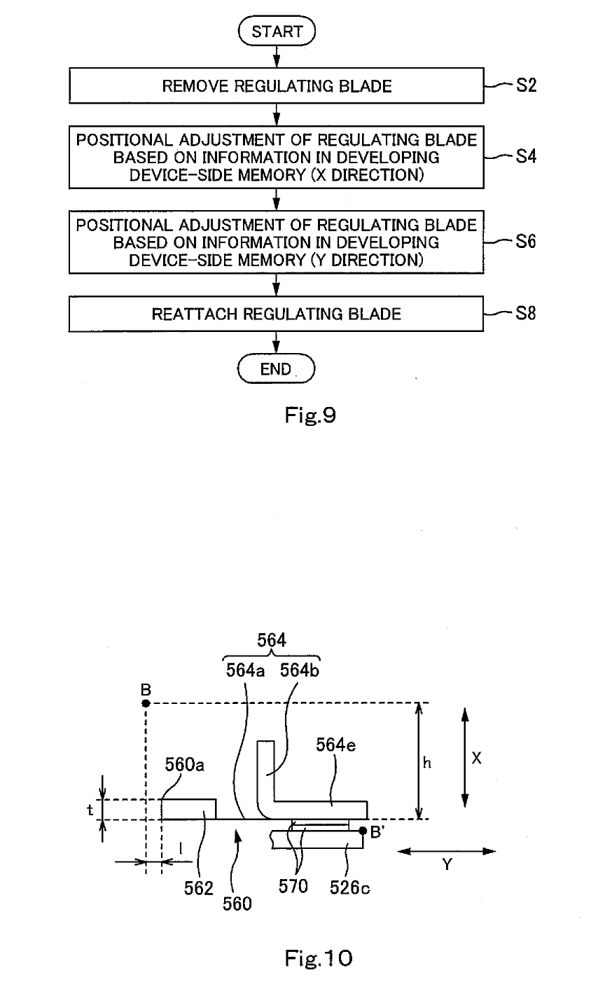

Here, a method for removing the regulating blade 560 from the above-described developing devices 51, 52, 53 and 54 (more specifically, the above-described holder 526) and reattaching a new regulating blade 560 for the purpose of the reuse or the like of developing devices is described with reference to FIGS. 9 and 10. FIG. 9 is a flow chart showing a method for reattaching the regulating blade 560. FIG. 10 is an explanatory diagram for describing a procedure for adjusting the attachment position of the regulating blade 560. It should be noted that in the description below, among the black developing device 51, magenta developing device 52, cyan developing device 53, and yellow developing device 54, the yellow developing device 54 is used as an example.

First, the regulating blade 560 is removed from the yellow developing device 54 in which the regulating blade 560 is provided (step S2). In such a case, following procedures are carried out to facilitate the removal of the regulating blade 560. Specifically, the yellow developing device 54 is initially taken apart into the holder 526 to which the regulating blade 560 and the developing roller 510 are attached, and the housing 540. Next, the developing roller 510 is removed from the holder 526. Then, the regulating blade 560 is removed from the holder 526 from which the developing roller 510 has been removed.

Subsequently, procedures for attaching a new regulating blade 560 (namely, the regulating blade 560 shown in FIG. 5) to the holder 526 from which the regulating blade 560 has been removed (namely, the holder 526 shown in FIG. 6) are carried out. Prior to the attachment, the attachment position of the new regulating blade 560 with respect to the holder 526 is adjusted. Two types of adjustment are carried out as the adjustment of the attachment position, i.e., the adjustment of the length from the front end 560a of the regulating blade 560 to the contacting section 562a (hereinafter, such a length is also referred to as the “protrusion amount”), and adjustment of the distance from the reference position to the short side direction other end portion 564e of the rubber supporting section 564 in the direction from the rubber section 562 toward the developing roller 510.

When performing such adjustment, the above-described regulating blade related information that is stored in the developing device-side memory 54a of the yellow developing device 54 is used. The regulating blade related information is, for example, information concerning the regulating blade 560 that has been provided in the yellow developing device 54 (namely, the regulating blade 560 removed in step S2), and is stored by a manufacturer in a predetermined storing area of the developing device-side memory 54a when the yellow developing device 54 is manufactured as a new developing device (i.e., not as a reused developing device). In the present embodiment, the information indicating the protrusion amount, information indicating the distance and information indicating the thickness of the rubber section 562 are stored in the developing device-side memory 54a as the regulating blade related information.

The adjustment of the attachment position of the regulating blade 560 is described below more specifically with reference to FIG. 10.

First, a distance h from the reference position (such a position is indicated with the symbol B in FIG. 10) to the short side direction other end portion 564e of the rubber supporting section 564 in the direction from the rubber section 562 toward the developing roller 510 (such a direction is indicated with the symbol X in FIG. 10) is adjusted (step S4). In such a case, the distance h of the regulating blade to be reattached to the yellow developing device 54 is adjusted based on information indicating distance ho and information indicating thickness to stored in the developing device-side memory 54a. Specifically, when the thickness t of the regulating blade 560 to be reattached is equal to the thickness to, the attachment position of the regulating blade 560 is adjusted so that the distance h is equal to the distance ho stored in the developing device-side memory 54a. On the other hand, when the thickness t of the regulating blade 560 to be reattached is larger (smaller) than the thickness to, the difference Δt is calculated, and the attachment position of the regulating blade 560 is adjusted so that the distance h has a value that is larger (smaller) by Δt than the distance ho stored in the developing device-side memory 54a.

It should be noted that the adjustment of the attachment position of the regulating blade 560 is performed by inserting the spacer 570 between the long side end portions 564c of the regulating blade 560 and the regulating blade supporting sections 526c of the holder 526. In other words, at this stage, the height of the regulating blade 560 with respect to the holder 526 is adjusted.

The reference position may be any position. In the present embodiment, the reference position is set to the position corresponding to the center of a hole of the developing roller supporting section 526b into which the shaft bearing 576 is joined (the position indicated by the symbol B in FIG. 10). However, the reference position may be the top of the regulating blade supporting section 526c (the position indicated by the symbol B′ in FIG. 10), for example.

Next, the protrusion amount is adjusted (step S6). As shown in FIG. 10, the attachment position of the regulating blade 560 is adjusted in the direction intersecting the above-described direction X (such a direction is indicated by the symbol Y in FIG. 10) in order to adjust the protrusion amount. As in step S4, in such a case, the protrusion amount of the regulating blade 560 to be reattached to the yellow developing device 54 is adjusted based on the information indicating protrusion amount stored in the developing device-side memory 54a. In the present embodiment, as an example of the information indicating protrusion amount, a distance lo from the reference position B to the front end 560a of the regulating blade 560 in the direction Y is stored in the developing device-side memory 54a. The attachment position of the new regulating blade 560 is adjusted so that such a distance 1 is equal to the distance lo stored in the developing device-side memory 54a.

In this way, the regulating blade 560 for which the distance h from the reference position B to the short side direction other end portion 564e of the rubber supporting section 564 in the direction X, and the protrusion amount of the regulating blade 560 have been adjusted, is affixed to the regulating blade supporting sections 526c of the holder 526 with screws, thereby ultimately fixed to the holder 526. After that, the developing roller 510 is attached to the holder 526 to which a new regulating blade 560 is fixed. The holder 526 to which the developing roller 510 is attached is attached to the housing 540, thereby completing the reattachment of the regulating blade 560 (step S8).

As described above, the method for reattaching the regulating blade 560 of the present embodiment includes a step of adjusting the protrusion amount of the regulating blade 560 to be reattached to the developing device, based on the information indicating protrusion amount of the regulating blade 560 that is stored in the developing device, thus the method for reattaching the regulating blade 560 can be more simplified. In other words, by using the information indicating protrusion amount stored in the developing device when adjusting the protrusion amount of the regulating blade 560, it becomes possible to attach the regulating blade 560 to the developing device in a simpler manner than a case in which the regulating blade 560 is attached to the developing device in manufacturing the developing device as a new developing device (i.e., not as a reused developing device).

In addition, with the method for reattaching the regulating blade 560 of the present embodiment, since the method includes a step of adjusting the distance of the regulating blade 560 to be reattached to the developing device based on information indicating distance from the reference position to the short side direction other end portion 564e of the rubber supporting section 564, in the direction from the rubber section 562 toward the developing roller 510, and information indicating the thickness of the rubber section 562, that are stored in the developing device, the method for reattaching the regulating blade 560 can be furthermore simplified.

### OTHER EMBODIMENTS ACCORDING TO THE FIRST EMBODIMENT

The method for reattaching the layer thickness regulating member of the present invention, etc., was described based on the foregoing first embodiment. However, the foregoing embodiment of the invention is for the purpose of elucidating the present invention and is not to be interpreted as limiting the present invention. The invention can of course be altered and improved without departing from the gist thereof and includes functional equivalents.

It should be noted that in the foregoing embodiment, an intermediate image transfer type full-color laser beam printer was described as an example of the image forming apparatus, but the present invention can also be adopted for various other types of image forming apparatuses, such as full-color laser beam printers that are not of the intermediate image transfer type, monochrome laser beam printers, copying machines, and facsimiles.

The photoconductor, too, is not limited to a so-called photosensitive roller, configured by providing a photosensitive layer to an outer circumference surface on a cylindrical conductive material, but may be configured by providing a photosensitive layer to a surface on a belt-type conductive material.

In the method for reattaching the regulating blade 560 of the foregoing embodiment, the method includes a step of adjusting the distance of the regulating blade 560 to be reattached to the developing device based on the information indicating the distance from the reference position to the short side direction other end portion 564e of the rubber supporting section 564, in the direction from the rubber section 562 toward the developing roller 510, and the information indicating the thickness of the rubber section 562, that is stored in the developing device. However, there is no limitation to this. For example, the distance may be adjusted based on the information indicating distance only, without using the information indicating the thickness of the rubber section 562.

For example, in cases where the rubber section 562 can be manufactured with good precision, it is highly possible that the above-described thickness t equals to the thickness to that is stored in the developing device-side memory 54a. Accordingly, in such cases or the like, by adjusting the distance based on the information indicating distance only without using the information indicating the thickness of the rubber section 562, it is possible to further simplify the method for reattaching the regulating blade 560 without lowering the precision in the positional adjustment of the regulating blade 560. It should be noted that naturally, it is not required for the developing device to possess the information indicating the thickness of the rubber section 562 in such cases.

Also, the step of adjusting the distance of the regulating blade 560 to be reattached to the developing device may be omitted. In other words, in the method for reattaching the regulating blade 560 of the foregoing embodiment, the positional adjustment in the direction X shown in step S4 and the positional adjustment in the direction Y shown in step S6 are carried out to adjust the position of the regulating blade 560. However, only the latter adjustment of the two may be carried out.

For example, in cases where the rubber section 562 can be manufactured with good precision, and the spacer 570 that is attached to the developing device is reused at the time of reattaching the regulating blade 560, it is highly possible that the above-described distance h and thickness t are equal to the distance ho and thickness to that are stored in the developing device-side memory 54a without the positional adjustment in the direction X shown in step S4. Accordingly, in such cases or the like, by omitting the positional adjustment in the direction X shown in step S4, it is possible to further simplify the method for reattaching the regulating blade 560 without lowering the precision in the positional adjustment of the regulating blade 560. It should be noted that naturally, it is not required for the developing device to possess the information indicating the distance from the reference position to the short side direction other end portion 564e of the rubber supporting section 564 in the direction from the rubber section 562 toward the developing roller 510, and the information indicating the thickness of the rubber section 562.

Also in the foregoing embodiment, information is stored in the developing device-side memories 51a, 52a, 53a and 54a provided in the developing device. However, there is no limitation to this. For example, information may be written on the developing device using writing instruments, stamps or the like.

However, the foregoing embodiment is more preferable in terms of avoiding soiling of the developing device.

In the foregoing embodiment, reattachment of a new regulating blade 560 to the developing device was used as an example to describe the method for reattaching the regulating blade 560. However, there is no limitation to this. For example, the present invention can be applied to cases where the wear condition of the regulating blade is checked after being removed from the developing device, and the regulating blade is reattached to the developing device when it is determined that replacement of the same is unnecessary.

Also in the foregoing embodiment, the method for reattaching the regulating blade 560 is described for a case where the regulating blade 560 is reattached to the developing device for the purpose of the recycle (reuse) of the developing device. However, there is no limitation to this. For example, the present invention can be applied to cases where reattachment of the regulating blade to the developing device becomes necessary in newly manufacturing a developing device.

### SECOND EMBODIMENT

### Method for Remanufacturing the Developing Device

As described in the section of “Disclosure of Invention”, the developing device is shipped after being assembled, in other words, after the developing roller 510, the regulating blade 560 and the like are attached to the developing device. In some cases, data indicating characteristic of the toner that has passed between the contacting section 562a and the developing roller 510 is obtained by actual measurement prior to the shipment (and also after the developing roller 510 and the regulating blade 560 are attached to the developing device).

For example, at the first rotation of the developing roller 510 after the developing device is assembled, the toner tends to leak from between the contacting section 562a and the developing roller 510. Therefore, a process in which the developing roller 510 is rotated until the toner ceases leaking is generally carried out prior to shipment of the developing device (before a purchaser obtains the developing device). When carrying out the process, data indicating the toner leakage degree can be obtained as the data by actually measuring the time required until the toner ceases leaking, etc. (it should be noted that if it is found through the process that a subject developing device shows an excessive toner leakage degree, and fails to satisfy the specification relating to the toner leakage degree, such a developing device may not be shipped).

The characteristic of the toner that has passed between the contacting section 562a and the developing roller 510 vary among developing devices. For example, when such a characteristic involves the toner leakage degree, among developing devices that have satisfied the specification for the toner leakage degree at the process and are to be shipped, some developing devices are favorable in terms of the characteristic (in other words, there is little leakage), and others are unfavorable in terms of the characteristic (in other words, there is much leakage).

Incidentally, developing devices are generally recycled (reused) from the viewpoint of resource saving, environmental protection, cost reduction or the like. When a toner in a developing device runs out as the developing device is used, the developing device is collected by a supplier or the like of the same. The supplier or the like refills the developing device with a toner to remanufacture the same.

When remanufacturing the developing device, it is preferable that the developing device that is unfavorable in terms of the characteristic is remanufactured as the developing device that is favorable in terms of the characteristic.

In the present embodiment, in order to achieve such an object, data indicating the characteristic (in this example, toner leakage degree) of the toner that has passed between the contacting section 562a and the developing roller 510 is actually measured, and such measured data is stored in the developing device. When remanufacturing the developing device, measures are taken by which the developing device that is unfavorable in terms of the characteristic can be remanufactured as the developing device that is favorable in terms of the characteristic, based on such data stored in the developing device.

Here, the data indicating the toner leakage degree is described first, and three working examples of the method for remanufacturing developing devices in order to achieve the above-described object are described. It should be noted that in the description below, among the black developing device 51, the magenta developing device 52, the cyan developing device 53, and the yellow developing device 54, the yellow developing device 54 is used as an example.

<<<Data Indicating the Toner Leakage Degree>>>

As described above, the data indicating the toner leakage degree is actually measured during the process in which the developing roller 510 is rotated until the toner ceases leaking prior to shipment of the developing device (before a purchaser obtains the developing device). The procedure for actually measuring such data and storing the same in the developing device is described here.

The process is carried out after the developing device is assembled, specifically, after the developing roller 510, the regulating blade 560 and the like are attached to the developing device. In the process of the present embodiment, initially, the developing roller 510 provided in the developing device is rotated for three minutes, and an operator visually observes the toner leakage degree (the toner that has leaked attaches to the developing device and the amount of the toner that has attached is visually observed). Then, if the toner leakage is significant, the toner that has attached to the developing device is removed and the developing roller 510 provided in the developing device is rotated for another three minutes (six minutes in total). The operator visually observes the toner leakage degree again. If the toner leakage is significant at this time as well, after removing the toner that has attached to the developing device, the developing roller 510 provided in the developing device is rotated for another three minutes (nine minutes in total). The operator visually observes the toner leakage degree again.

The process ends when the leakage becomes not significant (has ceased). Also, the process ends when the toner leakage is still significant even after rotating the developing roller 510 provided in the developing device for nine minutes. Such a developing device is determined as not satisfying the specification relating to the toner leakage degree, and is not shipped.

Next, the operator causes the data indicating the toner leakage degree to be stored in the developing device to be shipped. More specifically, “rank A (excellent)” is stored as the data indicating the toner leakage degree in developing devices with non-significant toner leakage after rotating the developing roller 510 for three minutes, “rank B (good)” in developing devices with non-significant toner leakage after rotating the developing roller 510 for six minutes, and “rank c (fair)” in developing devices with non-significant toner leakage after rotating the developing roller 510 for nine minutes. In this embodiment, the data is stored in the storing area of the above-described developing device-side memory 54a.

<<<Method for Remanufacturing the Developing Device>>>

Next, three working examples are described with regard to the method for remanufacturing the developing device. It should be noted that the developing roller 510 or the regulating blade 560 provided in the developing device wear as the developing device is used. However, in this embodiment, of the developing devices collected by suppliers or the like of the developing device, developing devices with a light degree of wear are subject to remanufacturing.

### REGARDING THE FIRST WORKING EXAMPLE

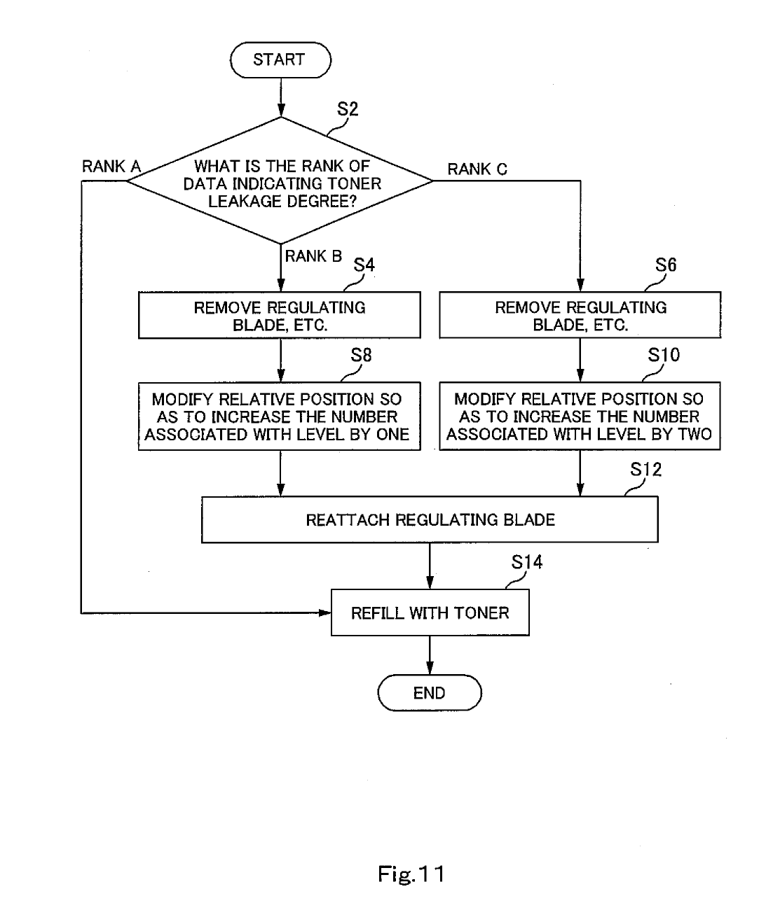

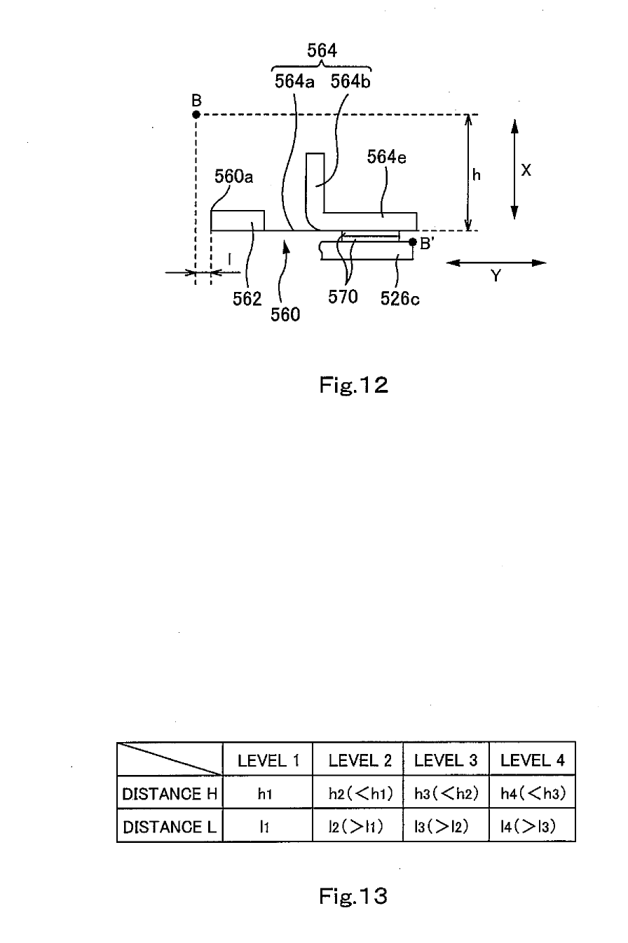

Now, the first working example of the method for remanufacturing the yellow developing device 54 is described with reference to FIGS. 11 through 13. FIG. 11 is a flow chart showing the first working example of the method for remanufacturing the yellow developing device 54. FIG. 12 is an explanatory diagram for describing the method for adjusting the attachment position of the regulating blade 560. FIG. 13 is a diagram showing four levels of the relative positions.

First, an operator refers to the data indicating the toner leakage degree that is stored in the storing area of the developing device-side memory 54a, and determines whether or not to modify the relative position of the regulating blade 560 with respect to the developing roller 510 based on the data (step S2). More specifically, if the data indicates “rank B” or “rank C” (“rank B” or “rank C” in step S2), it is determined to modify the relative position. If the data indicates “rank A” (“rank A” in step S2), it is determined not to modify the relative position.

Once it is determined to modify the relative position, the following procedures are carried out in order to facilitate the modification. That is, the yellow developing device 54 is initially taken apart into the holder 526 to which the regulating blade 560 and the developing roller 510 are attached, and the housing 540. Next, the developing roller 510 is removed from the holder 526. Then, the regulating blade 560 is removed from the holder 526 from which the developing roller 510 has been removed (step S4 and step S6).

Subsequently, the procedure for reattaching a regulating blade 560 (namely, the regulating blade 560 shown in FIG. 5) to the holder 526 from which that regulating blade 560 has been removed (namely, the holder 526 shown in FIG. 6) is carried out. During the attachment, the attachment position of the regulating blade 560 with respective to the holder 526 is modified (in other words, the relative position of the regulating blade 560 with respect to the developing roller 510 is modified).

Here, the method for modifying the attachment position (relative position) is described. Before describing the modification method, the method for adjusting the attachment position (relative position) that is carried out when manufacturing the yellow developing device 54 as a new developing device (i.e., not as a reused developing device), etc., is described first with reference to FIG. 12, and thereafter the method for modifying the attachment position (relative position) is described.

When the yellow developing device 54 is manufactured as a new developing device (i.e., not as a reused developing device), etc., the regulating blade 560 is attached to the holder 526. Prior to the attachment, the attachment position (relative position) of the regulating blade 560 with respect to the holder 526 is adjusted. Two types of adjustment are carried out as such adjustment, i.e., the adjustment of the length from the front end 560a of the regulating blade 560 to the contacting section 562a (hereinafter, such a length is also referred to as the “protrusion amount”), and adjustment of the distance from the reference position to the short side direction other end portion 564e of the rubber supporting section 564 in the direction from the rubber section 562 toward the developing roller 510.

First, a distance h from the reference position (such a position is indicated with the symbol B in FIG. 12) to the short side direction other end portion 564e of the rubber supporting section 564 in the direction from the rubber section 562 toward the developing roller 510 (such a direction is indicated with the symbol X in FIG. 12) is adjusted. As choices for the distance h that is adjusted, four choices shown in FIG. 13 (level 1 through level 4) are provided, and the distance h is adjusted to one of the four levels.

It should be noted that the adjustment of the attachment position of the regulating blade 560 is performed by inserting the spacer 570 between the long side direction end portions 564c of the regulating blade 560 and the regulating blade supporting sections 526c of the holder 526. In other words, at this stage, the height of the regulating blade 560 with respect to the holder 526 is adjusted. In addition, the reference position may be any position. In the present working example, the reference position is set to the position corresponding to the center of a hole of the developing roller supporting section 526b into which a shaft bearing 576 is joined (the position indicated by the symbol B in FIG. 12). However, the reference position may be set at the top of the regulating blade supporting section 526c (the position indicated by the symbol B′ in FIG. 12).

Next, the protrusion amount is adjusted. As shown FIG. 12, the attachment position of the regulating blade 560 is adjusted in the direction intersecting the above-described direction X (such a direction is indicated by the symbol Y in FIG. 12) in order to adjust the protrusion amount. In the present working example, the distance 1 from the reference position B to the front end 560a of the regulating blade 560 in the direction Y is adjusted in order to adjust the protrusion amount. In addition, as the distance h, as choices for the distance 1 that is adjusted, four choices shown in FIG. 13 (level 1 through level 4) are provided. The distance 1 is adjusted to one of the four levels.

Next, the method for modifying the attachment position (relative position) when remanufacturing the yellow developing device 54 is described. In modifying the attachment position, at least one of the above-described distance h and distance 1 is modified so as to increase the number associated with the level shown in FIG. 13. If the distance h is modified so as to increase the number associated with the level, the distance h becomes shorter, which increases the load of the regulating blade 560 with respect to the developing roller 510, and the charge amount of the toner that passes between the contacting section 562a and the developing roller 510 increases. Also, if the distance 1 is modified so as to increase the number associated with the level, the distance 1 becomes longer (since the protrusion amount decreases), which reduces the transporting amount of the toner, and the charge amount of the toner that passes between the contacting section 562a and the developing roller 510 increases (since it becomes possible for the contacting section 562a to efficiently charge a small amount of toner). Accordingly, when the distance h or the distance 1 is modified so as to increase the number associated with the level, it is possible to make the toner leakage less. Therefore, it is possible to remanufacture the yellow developing device 54 that is unfavorable in terms of the toner characteristic (toner leakage degree) as the yellow developing device 54 that is favorable in terms of the toner characteristic (toner leakage degree).

In addition, in the present working example, the modification extent of the relative position (attachment position) is changed based on the data. More specifically, if the data indicates “rank B”, one of the distance h and the distance 1 is modified so as to increase the number associated with the level by one. If the data indicates “rank C”, one of the distance h and the distance 1 is modified so as to increase the number associated with the level by two, or both of the distance h and the distance 1 are modified so as to increase the number associated with their levels by one.

In order to perform the above-described modification of relative position (attachment position) smoothly, information on a relative position before that relative position is modified is necessary. In the present working example, the regulating blade related information that is stored in the developing device-side memory 54a of the yellow developing device 54 is used as such information. That is, the regulating blade related information is relative position information indicating a relative position (attachment position) before that relative position (attachment position) is modified. For example, the regulating blade related information is stored by a manufacturer in a predetermined storing area of the developing device-side memory 54a when the yellow developing device 54 is manufactured as a new developing device (i.e., not as a reused developing device), as the above-described data indicating the toner leakage degree. In the present working example, the information indicating the protrusion amount (namely, distance 1) and the information indicating distance (namely, distance h) are stored in the developing device-side memory 54a as the regulating blade related information.

Description of the method for remanufacturing the yellow developing device 54 is continued going back to the flow chart, assuming that “13” (level 3) and “h2” (level 2) are respectively stored in the developing device-side memory 54a, as the information indicating the protrusion amount and the information indicating the distance.

If the data indicates “rank B” (“rank B” in step S2), after removal of the regulating blade 560 (step S4), the relative position (attachment position), that is, one of the distance h and the distance 1, is modified so as to increase the number associated with the level by one (step S8). In this case, the distance 1 is modified from “13” (level 3) to “14” (level 4).

If the data indicates “rank C” (“rank C” in step S2), after removal of the regulating blade 560 (step S6), one of the distance h and the distance 1 is modified so as to increase the number associated with the level by two, or both of the distance h and the distance 1 are modified so as to increase the number associated with their levels by one (step S10). In this case, since it is impossible to modify the distance 1 so as to increase the number associated with its level by two, the distance h is modified from “h2” (level 2) to “h4” (level 4).

In this way, the regulating blade 560 whose relative position (attachment position) is modified is affixed to the regulating blade supporting sections 526c of the holder 526 with screws, thereby ultimately fixed to the holder 526. After that, the developing roller 510 is attached to the holder 526 to which the regulating blade 560 is fixed. The holder 526 that is attached with the developing roller 510 is attached to the housing 540, thereby completing the reattachment of the regulating blade 560 and the like (reassembly of the yellow developing device 54) (step S12).

Then, the assembled yellow developing device 54 is refilled with toner (step S14) to be remanufactured.

It should be noted that in step S2, if the data indicates “rank A” (“rank A” in step S2), it is determined that the yellow developing device 54 is favorable in terms of the toner characteristic (toner leakage degree), and as described above, it is determined not to modify the relative position. In such a case, the yellow developing device 54 is refilled with toner without modifying the relative position (step S14) to be remanufactured.

As described above, the method for remanufacturing the developing device of the present working example includes a step of determining whether or not to modify the relative position of the regulating blade 560 with respect to the developing roller 510, based on the data that is actually measured after the developing roller 510 and the regulating blade 560 are attached to the yellow developing device 54 and stored in the yellow developing device 54, and indicates the characteristic of the toner that has passed between the contacting section 562a and the developing roller 510; and modifying the relative position when it is determined to perform the modification. Therefore, it becomes possible to improve performance of the yellow developing device 54 when remanufacturing the same.

It should be noted that in the foregoing working example, in the step of modifying the relative position, the modification extent of the relative position is changed based on the data. However, there is no limitation to this. In other words, in the foregoing working example, if the data indicates “rank B”, one of the distance h and the distance 1 is modified so as to increase the number associated with the level by one, and if the data indicates “rank C”, one of the distance h and the distance 1 is modified so as to increase the number associated with the level by two, or both of the distance h and the distance 1 are modified so as to increase the number associated with their levels by one. However, there is no limitation to this. One of the distance h and the distance 1 may be modified so as to increase the number associated with the level by one, whether the data indicates “rank B” or “rank C”.

However, the foregoing working example is more preferable in that the performance of the yellow developing device 54 can be more suitably improved when remanufacturing the same.

Also in the foregoing working example, the regulating blade related information indicating a relative position before that relative position is modified is stored in the yellow developing device 54. In the step of modifying the relative position, the relative position is modified using the regulating blade related information. However, there is no limitation to this.

For example, the regulating blade related information may not be stored in the yellow developing device 54, and a relative position before that relative position is modified may be measured and obtained before the regulating blade 560 is removed from the yellow developing device 54 in step S4 and step S6, and the obtained relative position may be used to modify the relative position.

However, the foregoing working example is more preferable in that procedures involved in the method for remanufacturing the yellow developing device 54 can be simplified.

### REGARDING THE SECOND WORKING EXAMPLE

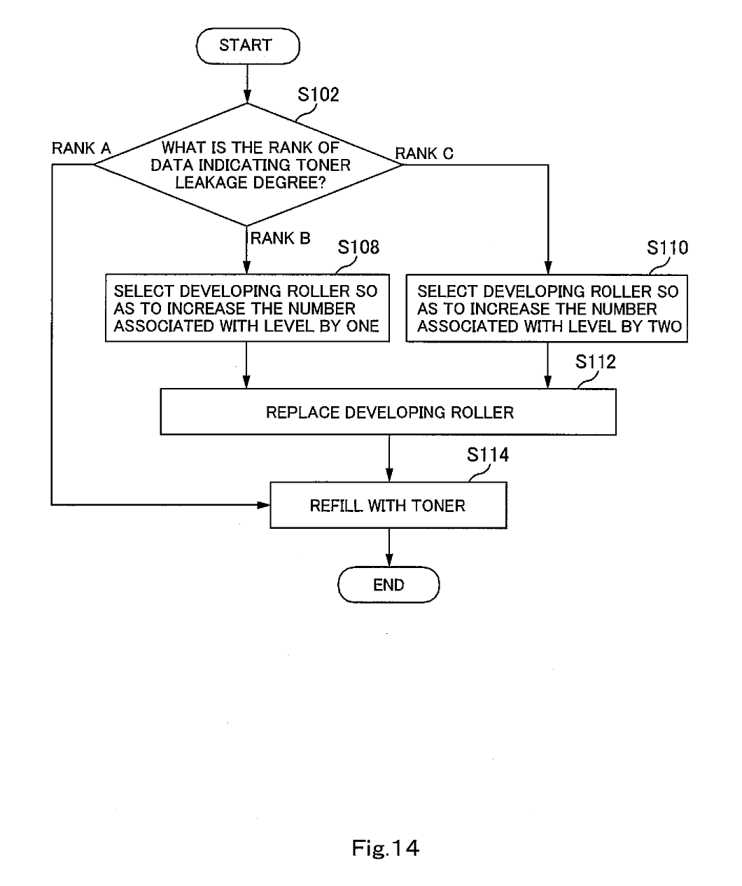

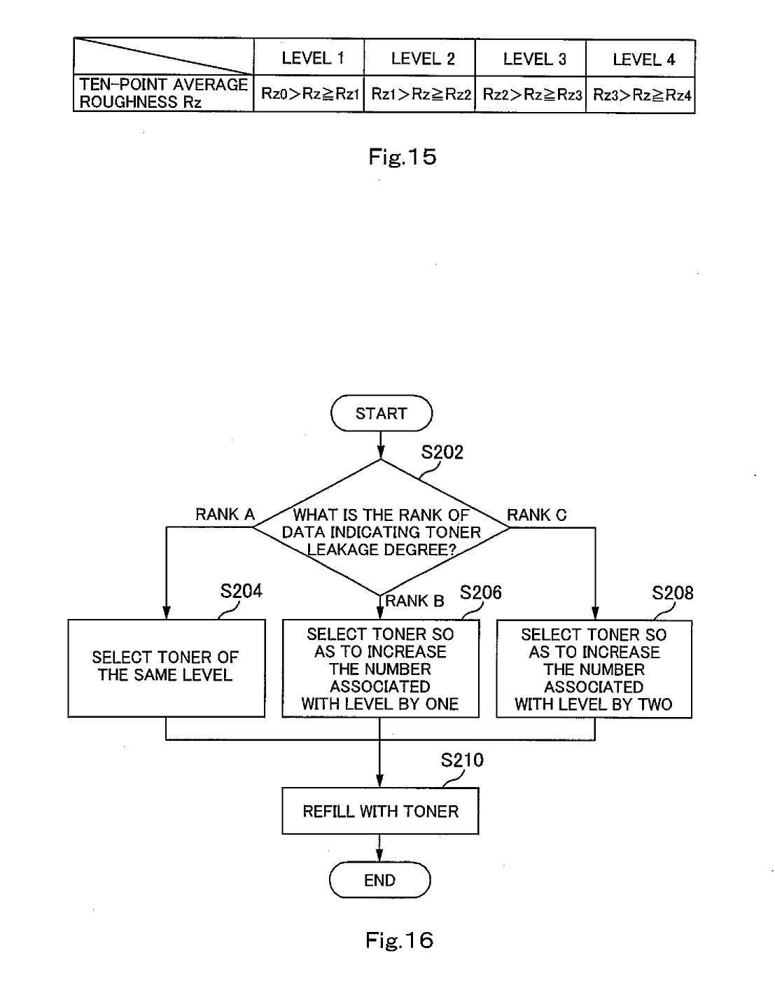

Next, the second working example of the method for remanufacturing the yellow developing device 54 is described with reference to FIGS. 14 and 15. FIG. 14 is a flow chart showing the second working example of the method for remanufacturing the yellow developing device 54. FIG. 15 is a diagram showing four levels of the developing roller 510.

First, an operator refers to the data indicating the toner leakage degree that is stored in the storing area of the developing device-side memory 54a, and determines whether or not to replace the developing roller 510 with another developing roller 510 based on the data (step S102). More specifically, if the data indicates “rank B′ or “rank C” (“rank B” or “rank C” in step S102), it is determined to replace the developing roller 510. If the data indicates “rank A” (“rank A” in step S102), it is determined not to replace the developing roller 510.

Now, the method for replacing the developing roller 510 with another developing roller 510 is described.

When the yellow developing device 54 is manufactured as a new developing device (i.e., not as a reused developing device), etc., one developing roller 510 is selected from among a plurality of developing rollers 510 that mutually have different surface roughness, and the selected developing roller 510 is attached to the yellow developing device 54. In the present working example, as shown in FIG. 15, the developing rollers 510 are classified into four levels based on their surface roughness (in this working example, ten-point average roughness Rz is adopted, but there is no limitation to this). A developing roller 510 that belongs to one of the levels is attached to the yellow developing device 54.

When replacing the developing roller 510 with another developing roller 510, the developing roller 510 is replaced so as to increase the number associated with the level to which another developing roller 510 after replacement belongs compared with the number associated with the level to which the developing roller 510 before replacement belongs. By performing replacement in such a manner, the ten-point average surface roughness Rz of the developing roller 510 after replacement is smaller than that of the developing roller 510 before replacement. Therefore, the transporting amount of the toner decreases and the charge amount of the toner that passes between the contacting section 562a and the developing roller 510 increases (since it becomes possible for the contacting section 562a to efficiently charge such a small amount of toner). Accordingly, the yellow developing device 54 whose developing roller 510 is replaced in this way has less toner leakage, which makes it possible to remanufacture the yellow developing device 54 that is unfavorable in terms of the toner characteristic (toner leakage degree) as the yellow developing device 54 that is favorable in terms of the toner characteristic (toner leakage degree).

Further in the present working example, another developing roller 510 is selected from among a plurality of developing rollers 510 that mutually have different surface roughness based on the data. More specifically, if the data indicates “rank B”, another developing roller 510 is selected so as to increase the number associated with the level of the another developing roller 510 after replacement by one, compared with the number associated with the level to which the developing roller 510 before replacement belongs. If the data indicates “rank C”, another developing roller 510 is selected so as to increase the number associated with the level of the another developing roller 510 after replacement by two, compared with the number associated with the level to which the developing roller 510 before replacement belongs.

In order to perform the above-described replacement of the developing roller 510 smoothly, the information on the surface roughness of the developing roller 510 before replacement is necessary. In the present working example, the surface roughness information stored in the developing device-side memory 54a of the yellow developing device 54 is used as such information. In other words, the surface roughness information is information indicating the surface roughness of the developing roller 510 that has been provided in the yellow developing device 54 before replacement thereof that is the surface roughness when that developing roller 510 was attached to the yellow developing device 54. For example, the surface roughness information is stored by a manufacturer in a predetermined storing area of the developing device-side memory 54a when the yellow developing device 54 is manufactured as a new developing device (i.e., not as a reused developing device), as the above-described data indicating the toner leakage degree. In the present working example, the level to which the developing roller 510 belongs, that is one of level 1 through level 4, is stored in the developing device-side memory 54a as the surface roughness information.

Description of the method for remanufacturing the yellow developing device 54 is continued going back to the flow chart, assuming that “level 2” is stored in the developing device-side memory 54a as the surface roughness information.

If the data indicates “rank B” (“rank B” in step S102), another developing device 510 is selected so as to increase the number associated with the level to which the another developing device 510 after replacement belongs by one compared with the number associated with the level to which the developing roller 510 before replacement belongs (step S108). Specifically, in this case, the developing roller 510 that belongs to level 3 is selected.

If the data indicates “rank C” (“rank C” in step S102), another developing device 510 is selected so as to increase the number associated with the level to which the another developing device 510 after replacement belongs by two compared with the number associated with the level to which the developing roller 510 before replacement belongs (step S110). Specifically, in this case, the developing roller 510 that belongs to level 4 is selected.

Then, in order to replace the developing roller 510 with the selected another developing roller 510, the yellow developing device 54 is initially taken apart into the holder 526 to which the developing roller 510 is attached, and the housing 540. Next, the developing roller 510 is removed from the holder 526. Then, the developing roller 510 that is selected in step S108 or step S110 is attached to the holder 526. Further, the holder 526 attached with the developing roller 510 is attached to the housing 540, thereby completing reassembly of the yellow developing device 54 (replacement of the developing roller 510) (step S112).

Then, the assembled yellow developing device 54 is refilled with toner (step S114) to be remanufactured.

It should be noted that in step S102, if the data indicates “rank A” (“rank A” in step S102), it is determined that the yellow developing device 54 is favorable in terms of the toner characteristic (toner leakage degree), and as described above, it is determined not to replace the developing roller 510 with another developing roller 510. In such a case, the yellow developing device 54 is refilled with toner without replacing the developing roller 510 (step S114) to be remanufactured.

As described above, the method for remanufacturing the developing device of the present working example includes a step of determining whether or not to replace the developing roller 510 with another developing roller 510, based on the data that is actually measured after the developing roller 510 and the regulating blade 560 are attached to the yellow developing device 54 and stored in the yellow developing device 54, and indicates the characteristic of the toner that has passed between the contacting section 562a and the developing roller 510; and replacing the developing roller 510 when it is determined to perform the replacement. Therefore, it becomes possible to improve performance of the yellow developing device 54 when remanufacturing the same.

It should be noted that in the foregoing working example, in the step of replacing the developing roller 510 with the another developing roller 510, the another developing roller 510 is selected from among a plurality of developing rollers 510 that mutually have different surface roughness based on the data. However, there is no limitation to this. In other words, in the foregoing working example, if the data indicates “rank B”, another developing roller 510 is selected so as to increase the number associated with the level to which the another developing roller 510 after replacement belongs by one, compared with the number associated with the level to which the developing roller 510 before replacement belongs, and if the data indicates “rank C”, another developing roller 510 is selected so as to increase the number associated with the level to which the another developing roller 510 belongs by two, compared with the number associated with the level to which the developing roller 510 before replacement belongs. However, there is no limitation to this. Another developing roller 510 may be selected so as to increase the number associated with the level to which the another developing roller 510 after replacement belongs by one compared with the number associated with the level to which the developing roller 510 before replacement belongs, whether the data indicates “ranks B” or “rank C”.

However, the foregoing working example is more preferable in that the performance of the yellow developing device 54 can be more suitably improved when remanufacturing the same.

Also in the foregoing working example, surface roughness information that indicates the surface roughness of the developing roller 510 that has been provided in the yellow developing device 54 before replacement thereof that is the surface roughness when the developing roller 510 was attached to the yellow developing device 54, is stored in the yellow developing device 54. In the step of replacing the developing roller 510 with the another developing device 510, the another developing device 510 is selected from among a plurality of developing rollers 510 that mutually have different surface roughness using the surface roughness information. However, there is no limitation to this.

For example, the surface roughness information may not be stored in the yellow developing device 54, and the surface roughness of the developing roller 510 provided in the yellow developing device 54 before replacement thereof may be obtained from materials relating to the developing roller 510 that are separately kept, and the obtained surface roughness may be used to select the another developing device 510.

However, the foregoing working example is more preferable in that procedures involved in the method for remanufacturing the yellow developing device 54 can be simplified.

### REGARDING THE THIRD WORKING EXAMPLE

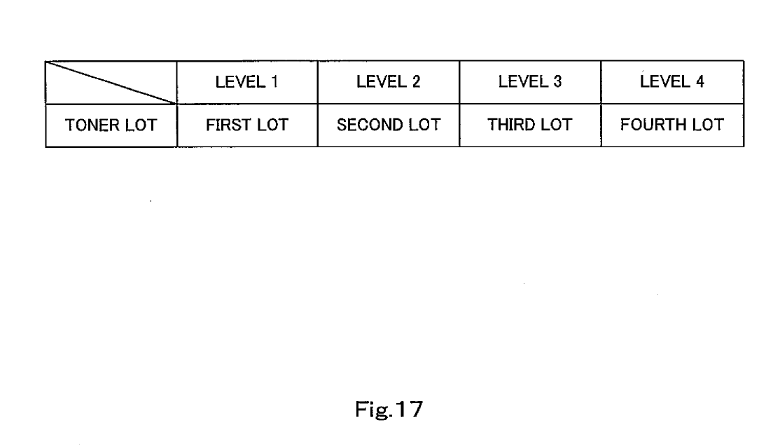

Next, the third working example of the method for remanufacturing the yellow developing device 54 is described with reference to FIGS. 16 and 17. FIG. 16 is a flow chart showing the third working example of the method for remanufacturing the yellow developing device 54. FIG. 17 is a diagram showing four levels of the toner.

First, an operator refers to the data indicating the toner leakage degree that is stored in the storing area of the developing device-side memory 54a, and selects a toner for refilling the yellow developing device 54 based on the data (step S202).

Now, the method for selecting the toner for refilling the yellow developing device 54 is described more specifically.

When the yellow developing device 54 is manufactured as a new developing device (i.e., not as a reused developing device), etc., the toner for filling the yellow developing device 54 is selected from among a plurality of types of lots. In the present working example, as shown in FIG. 17, lots of four levels are prepared and the yellow developing device 54 is filled with one of these lots.

When refilling the yellow developing device 54 with toner, the toner for refilling the yellow developing device 54 is selected from among the lots of four levels based on the data. More specifically, if the data indicates “rank B” or “rank C”, the toner for refilling the yellow developing device 54 is selected so as to increase the number associated with the level to which the toner that refills the yellow developing device 54 belongs, compared with the number associated with the level to which the toner that filled the developing device 54 before being refilled with toner belongs.

The lots of four levels differ from one another in types or amounts of external additives contained therein, and the transportability and chargeability of the toners vary due to such difference. In the present working example, as the number associated with the level increases, the transporting amount of the toner tends to decrease and the charge amount of the toner tends to increase. Accordingly, when the toner for refilling the yellow developing device 54 is selected in the manner described above, the yellow developing toner 54 that is refilled with the toner to be remanufactured has less toner leakage. Therefore, it is possible to remanufacture the yellow developing device 54 that is unfavorable in terms of the toner characteristic (toner leakage degree) as the yellow developing device 54 that is favorable in terms of the toner characteristic (toner leakage degree).

In addition, in the present working example, if the data indicates “rank B”, the toner for refilling the yellow developing device 54 is selected so as to increase the number associated with the level to which the toner that refills the yellow developing device 54 belongs by one, compared with the number associated with the level to which the toner that has filled the yellow developing device 54 before being refilled with toner belongs. If the data indicates “rank C”, the toner for refilling the yellow developing device 54 is selected so as to increase the number associated with the level to which the toner that refills the yellow developing device 54 belongs by two, compared with the number associated with the level to which the toner that has filled the yellow developing device 54 before being refilled with toner belongs.

It should be noted that if the data indicates “rank A”, it is determined that the yellow developing device 54 is favorable in terms of the toner characteristic (toner leakage degree), and the lot of the same type as the lot that has filled the yellow developing device 54 before being refilled with toner is selected as the toner for refilling the yellow developing device 54.

In order to perform the above-described selection of the toner smoothly, the information on the toner that has filled the yellow developing device 54 before being refilled with toner is necessary. In the present working example, the toner information stored in the developing device-side memory 54a of the yellow developing device 54 is used as such information. In other words, the toner information is information that specifies the toner that has filled the yellow developing device 54 before being refilled with toner. For example, the toner information is stored in a predetermined storing area of the developing device-side memory 54a by a manufacturer when the yellow developing device 54 is manufactured as a new developing device (i.e., not as a reused developing device), as the above-described data indicating the toner leakage degree. In the present working example, the lot information of the toner, that is, one of the first lot (level 1) through the fourth lot (level 4), is stored in the developing device-side memory 54a as the toner information.

Description of the method for remanufacturing the yellow developing device 54 is continued going back to the flow chart, assuming that “second lot (level 2)” is stored in the developing device-side memory 54a as the toner information.

If the data indicates “rank A” (“rank A” in step S202), a lot that is the same (of the same level) as the lot that has filled the yellow developing device 54 before being refilled with toner is selected as the toner for refilling the yellow developing device 54 (step S204). Specifically, in this case, the second lot (level 2) is selected.

If the data indicates “rank B” (“rank B” in step S202), the toner for refilling the yellow developing device 54 is selected so as to increase the number associated with the level to which the toner that refills the yellow developing device 54 belongs by one, compared with the number associated with the level to which the toner that has filled the yellow developing device 54 before being refilled with toner belongs (step S206). Specifically, in this case, the third lot (level 3) is selected.

If the data indicates “rank C” (“rank C” in step S202), the toner for refilling the yellow developing device 54 is selected so as to increase the number associated with the level to which the toner that refills the yellow developing device 54 belongs by two, compared with the number associated with the level to which the toner that has filled the yellow developing device 54 before being refilled with toner belongs (step S208). Specifically, in this case, the fourth lot (level 4) is selected.

Then, the yellow developing device 54 is refilled with the toner selected in one of steps S204, S206 and S208 (step S210) to be remanufactured.

As described above, the method for remanufacturing the developing device of the present working example includes a step of refilling with the toner selected based on the data that is actually measured after the developing roller 510 and the regulating blade 560 are attached to the yellow developing device 54 and stored in the yellow developing device 54, and indicates the characteristic of the toner that has passed between the contacting section 562a and the developing roller 510. Therefore, it becomes possible to improve performance of the yellow developing device 54 when remanufacturing the same.

It should be noted that in the foregoing working example, the toner information that specifies the toner that has filled the yellow developing device 54 before being refilled with toner is stored in the yellow developing device 54, and in the step of refilling with toner, the toner for refilling the developing device 54 is selected based on the toner information. However, there is no limitation to this.

For example, the toner information may not be stored in the yellow developing device 54, and the information for specifying the toner that has filled the yellow developing device 54 before being refilled with toner may be obtained from materials relating to the toner that are separately kept, and the obtained information may be used to select the toner for refilling the developing device 54.

However, the foregoing working example is more preferable in that procedures involved in the method for remanufacturing the yellow developing device 54 can be simplified.

### OTHER EMBODIMENTS ACCORDING TO THE SECOND EMBODIMENT

The method for remanufacturing the developing device according to the present invention for example was described based on the foregoing second embodiment. However, the foregoing embodiment of the invention is for the purpose of elucidating the present invention and is not to be interpreted as limiting the present invention. The invention can of course be altered and improved without departing from the gist thereof and includes functional equivalents.

It should be noted that in the foregoing embodiment, an intermediate image transfer type full-color laser beam printer was described as an example of the image forming apparatus, but the present invention can also be adopted for various other types of image forming apparatuses, such as full-color laser beam printers that are not of the intermediate image transfer type, monochrome laser beam printers, copying machines, and facsimiles.

The photoconductor, too, may not be limited to a so-called photodetection roller, configured by providing a photosensitive layer to an outer circumference surface on a cylindrical conductive material, but may be configured by providing a photosensitive layer to a surface on a belt-type conductive material.

In the foregoing embodiment, three working examples were described as examples of the method for remanufacturing developing device. However, they may be adopted in combination. For example, if the data indicates “rank C”, it is possible that another developing roller 510 is selected so as to increase the number associated with the level to which the another developing roller 510 after replacement belongs by one, compared with the number associated with the level to which the developing roller 510 before replacement belongs, and further, the toner for refilling the yellow developing device 54 is selected so as to increase the number associated with the level to which the toner that refills the yellow developing device 54 belongs by one, compared with the number associated with the level to which the toner that has filled the yellow developing device 54 before being refilled with toner belongs.

Also, in the foregoing embodiment, the data indicating the toner leakage degree, the regulating blade related information, the surface roughness information, and the toner information are stored in the developing device-side memories 51a, 52a, 53a and 54a provided in the developing device. However, there is no limitation to this. For example, such information may be written on the developing device using writing instruments, stamps or the like.

However, the foregoing embodiment is more preferable in terms of avoiding soiling of the developing device.

In the foregoing embodiment, as data that is actually measured after the developing roller 510 and the regulating blade 560 are attached to the developing device and stored in the developing device, and indicates the characteristic of the toner that has passed between the contacting section 562a and the developing roller 510, the data indicating the toner leakage degree is used as an example. However, there is no limitation to this. Any data may be used so long as it indicates the characteristic of the toner that has passed between the contacting section 562a and the developing roller 510. Also in the foregoing embodiment, when the process is performed in which the developing roller 510 is rotated until the toner ceases leaking, the time required until the toner ceases leaking is actually measured to obtain the data indicating the toner leakage degree. However, there is no limitation to this. For example, when such a process is performed, the data indicating the toner leakage degree may be obtained by actually measuring the extent of toner leakage by visual observation or by other methods.

### THIRD EMBODIMENT

### Method for Remanufacturing the Developing Device

As described in the section of “Disclosure of Invention”, it is known that whether the characteristic of the toner in the developing device (transportability or chargeability of toner, for example) is favorable or unfavorable depends on the relative position of the regulating blade 560 with respect to the developing roller 510, the surface roughness of the developing roller 510, the type (lot) of the toner for filling the developing device or the like.

Accordingly, when a developing device is manufactured, in some cases the above three parameters are selected so as to make the characteristic favorable. For example, a plurality of choices are provided respectively as choices for the relative position that is adjusted, the surface roughness of the developing roller 510 that is attached to the developing device, and the toner that fills the developing device. One choice is selected appropriately from each of the choice groups to select a combination of choices that makes the characteristic favorable.

Incidentally, developing devices are generally reused from the viewpoint of resource saving, environmental protection, cost reduction or the like. When a toner in a developing device runs out as the developing device is used, the developing device is collected by a supplier or the like of the same. The supplier or the like refills the developing device with a toner to remanufacture the same.

Also in such a case, the surface roughness of the developing roller 510 provided in the remanufactured developing device can be different from the surface roughness of the developing roller 510 of the developing device when manufactured as a new developing device (i.e., not as a reused developing device). For example, such an occasion may occur when the developing roller 510 is replaced in remanufacturing the developing device due to significant wear of the developing roller 510.

In such an occasion, while it is necessary to reselect a combination that makes the characteristic favorable, selecting such a combination from the beginning makes the procedures for remanufacturing the developing device complicated.

In the present embodiment, in order to solve such a problem, when reselecting a combination that makes the characteristic favorable, such a combination is not reselected from the beginning and instead, the surface roughness value of the developing roller 510 provided in the developing device (namely, the developing roller 510 provided in the remanufactured developing device) is obtained in refilling with toner, and the modification of the relative position or selection (change) of the toner used for refilling are carried out based on the obtained value as well as the surface roughness of the developing roller stored in the developing device (specifically, the surface roughness of the developing roller 510 when the developing device was manufactured as a new developing device), thereby reselecting a combination that makes the characteristic favorable.

In addition, when the developing device is remanufactured, the type (lot) of the toner used for refilling at such a time can be different from the type (lot) of the toner used for filling when the developing device was manufactured as a new developing device.

In such an occasion as well, while it is necessary to reselect a combination that makes the characteristic favorable, reselecting such a combination from the beginning makes the procedures for remanufacturing the developing device complicated.

In the present embodiment, in order to solve such a problem, when reselecting a combination that makes the characteristic favorable, such a combination is not reselected from the beginning and instead, toner information that specifies the toner used for refilling (such toner information shall be referred to as second toner information as an example of second developer information) is obtained, and the modification of the relative position or selection of another developing roller 510 (replacement with another developing roller 510) are carried out based on the obtained second toner information as well as the first toner information stored in the developing device (specifically, for example, the information on the toner used for filling when the developing device was manufactured as a new developing device), thereby reselecting a combination that makes the characteristic favorable.

Two working examples for the former method for remanufacturing the developing device (referred to as the first and second working examples) and two working examples for the latter method for remanufacturing the developing device (referred to as the third and fourth working examples) are described below. It should be noted that in the following working examples, among the black developing device 51, the magenta developing device 52, the cyan developing device 53, and the yellow developing device 54, the yellow developing device 54 is described as an example.

### REGARDING THE FIRST WORKING EXAMPLE

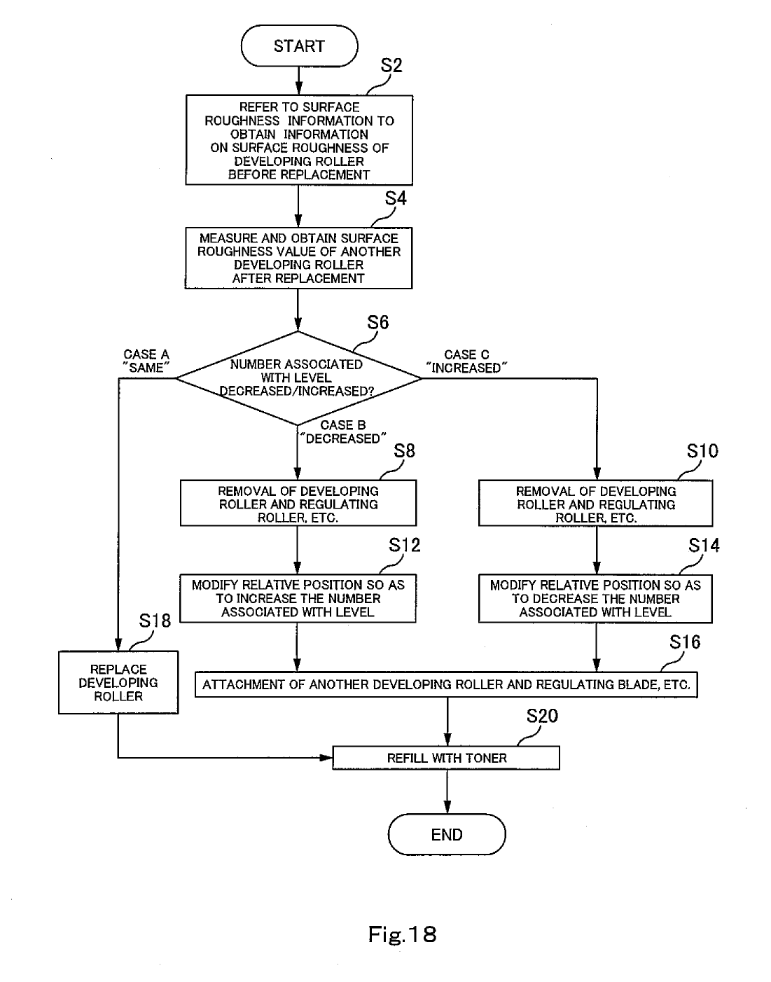

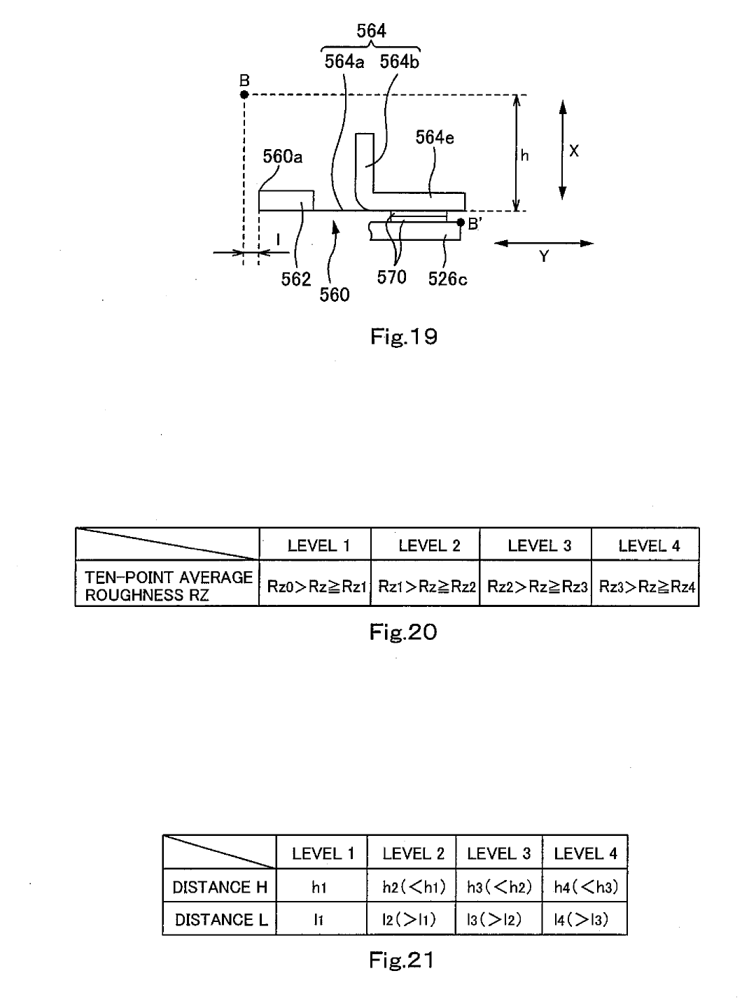

Next, the first working example of the method for remanufacturing the yellow developing device 54 is described with reference to FIGS. 18 to 21. FIG. 18 is a flow chart showing the first working example of the method for remanufacturing the yellow developing device 54. FIG. 19 is an explanatory diagram for describing the method for adjusting the attachment position of the regulating blade 560. FIG. 20 is a diagram showing four levels of the developing roller 510. FIG. 21 is a diagram showing four levels of the relative position. It should be noted that since the developing roller 510 provided in the yellow developing device 54 wears as the yellow developing device 54 is used, in this working example, the developing roller 510 is replaced with another developing roller 510 when remanufacturing the yellow developing device 54. Also, the type (lot) of the toner for refilling the yellow developing device 54 is the same as the type (lot) of the toner that has filled the yellow developing device 54 before refill with the toner.

First, an operator refers to the above surface roughness information that is stored in the developing device-side memory 54a of the yellow developing device 54, and obtains the information on the surface roughness of the developing roller 510 before replacement (step S2).

It should be noted that the surface roughness information is the information indicating the surface roughness of the developing roller 510 that has been provided in the yellow developing device 54 before replacement thereof that is the surface roughness when that developing roller 510 was attached to the yellow developing device 54. For example, the surface roughness information is stored by a manufacturer in a predetermined storing area of the developing device-side memory 54a when the yellow developing device 54 is manufactured as a new developing device (namely, not as a reused developing device).

Furthermore, when the yellow developing device 54 is manufactured as a new developing device and the like, the developing roller 510 is selected from among a plurality of developing rollers 510 that mutually have different surface roughness, and the selected developing roller 510 is attached to the yellow developing device 54. In the present working example, as shown in FIG. 20, the developing rollers 510 are classified into four levels based on their surface roughness (in this example, ten-point average roughness Rz is adopted, but there is no limitation to this). The developing roller 510 in any one of the levels is attached to the yellow developing device 54. The level to which the developing roller 510 belongs, namely, one of the levels from level 1 to level 4 is stored in the developing device—side memory 54a as for the surface roughness information.

Then, the operator obtains the surface roughness value of the another developing roller 510 after replacement, namely, the developing roller 510 provided in the yellow developing device 54 when refilling the yellow developing device 54 with toner (step S4). In the present working example, in order to obtain a precise value, the surface roughness value is obtained by measuring the surface roughness value.

Subsequently, the operator modifies the relative position of the regulating blade 560 with respect to the developing roller 510 based on the surface roughness information obtained in step S2 and the surface roughness value obtained in step S4 (“case B” and “case C” in step S6).

In such a case, first, following procedures are carried out in order to facilitate the modification. That is, the yellow developing device 54 is initially taken apart into the holder 526 to which the regulating blade 560 and the developing roller 510 are attached, and the housing 540. Next, the developing roller 510 is removed from the holder 526. Then, the regulating blade 560 is removed from the holder 526 from which the developing roller 510 has been removed (step S8 and step S10).

Subsequently, the procedure for reattaching the regulating blade 560 (namely, the regulating blade 560 shown in FIG. 5) to the holder 526 from which that regulating blade 560 has been removed (namely, the holder 526 shown in FIG. 6) is carried out. During the attachment, the attachment position of the regulating blade 560 with respect to the holder 526 is modified (in other words, the relative position of the regulating blade 560 with respect to the developing roller 510 is modified).

Here, the method for modifying the attachment position (relative position) is described. Before describing such a modification method, the method for adjusting the attachment position (relative position) that is carried out when manufacturing the yellow developing device 54 as a new developing device (namely, not as a reused developing device), etc., is described first with reference to FIG. 19, and thereafter, the method for modifying the attachment position (relative position) is described.

When the yellow developing device 54 is manufactured as a new developing device (namely, not as a reused developing device), etc., the regulating blade 560 is attached to the holder 526. Prior to the attachment, the attachment position (relative position) of the regulating blade 560 with respect to the holder 526 is adjusted. Two types of adjustment are carried out as such adjustment, namely, the adjustment of the length from the front end 560a of the regulating blade 560 to the contacting section 562a (hereinafter, such a length is also referred to as the “protrusion amount”), and adjustment of the distance from the reference position to the short side direction other end portion 564e of the rubber supporting section 564 in the direction from the rubber section 562 toward the developing roller 510.

First, a distance h from the reference position (such a position is indicated with the reference character B in FIG. 19) to the short side direction other end portion 564e of the rubber supporting section 564 in the direction from the rubber section 562 toward the developing roller 510 (such a direction is indicated with the reference character X in FIG. 19) is adjusted. As choices for the distance h that is to be adjusted, four choices shown in FIG. 21 (level 1 through level 4) are provided, and the distance h is adjusted to one of the four levels.

It should be noted that the adjustment of the attachment position of the regulating blade 560 is performed by inserting the spacer 570 between the long side direction end portions 564c of the regulating blade 560 and the regulating blade supporting sections 526c of the holder 526. In other words, at this stage, the height of the regulating blade 560 with respect to the holder 526 is adjusted. In addition, the reference position may be any position. In the present working example, the reference position is set to the position corresponding to the center of a hole of the developing roller supporting section 526b into which a shaft bearing 576 is joined (the position indicated by the reference character B in FIG. 19). However, the reference position may be set at the top of the regulating blade supporting section 526c (the position indicated by the reference character B′ in FIG. 19).

Next, the protrusion amount is adjusted. As shown in FIG. 19, the attachment position of the regulating blade 560 is adjusted in the direction intersecting the above-described direction X (such a direction is indicated by the reference character Y in FIG. 19) in order to adjust the protrusion amount. In the present working example, the distance 1 from the reference position B to the front end 560a of the regulating blade 560 in the direction Y is adjusted in order to adjust the protrusion amount. In addition, as the distance h, four choices shown in FIG. 21 (level 1 through level 4) are provided as choices for the distance 1 that is to be adjusted. The distance 1 is adjusted to one of the four levels.

Next, the method for modifying the attachment position (relative position) when remanufacturing the yellow developing device 54 is described. When modifying the attachment position, it is first determined to which level of the four levels shown in FIG. 20 the surface roughness value obtained in step S4 belongs. Then, it is obtained to what extent the number associated with the specified level (namely, the level to which another developing roller 510 after replacement belongs) has decreased (increased) compared with the number associated with the surface roughness information obtained in step S2 (namely, the level to which the developing roller 510 before replacement belongs). If the number associated with the specified level has decreased (increased), at least one of the above-described distance h and distance 1 is modified to the opposite direction, that is, in the direction to increase (decrease) the number associated with the levels shown in FIG. 20.

When the number associated with the level to which another developing roller 510 after replacement belongs is smaller than the number associated with the level to which the developing roller 510 before replacement belongs, in other words, when the ten-point average roughness Rz of another developing roller 510 after replacement is larger than the ten-point average roughness Rz of the developing roller 510 before replacement, the transporting amount of the toner in the remanufactured yellow developing device 54 becomes larger than the appropriate transporting amount that was suitably adjusted when the yellow developing device 54 was manufactured as a new developing device, etc. Accordingly, the charge amount of the toner that passes between the contacting section 562a and the developing roller 510 in the remanufactured yellow developing device 54 may be lower than the appropriate charge amount that was suitably adjusted when the yellow developing device 54 was manufactured as a new developing device, etc.

If the distance h is modified so as to increase the number associated with the level, the distance h becomes shorter, which increases the load of the regulating blade 560 with respect to the developing roller 510, and the charge amount of the toner that passes between the contacting section 562a and the developing roller 510 increases. As a result, if the distance h is modified so as to increase the number associated with the level under the above-described situation, the charge amount in the remanufactured yellow developing device 54 can be adjusted to the appropriate charge amount. Also, if the distance 1 is modified so as to increase the number associated with the level, the distance 1 becomes longer (since the protrusion amount decreases), which reduces the transporting amount of the toner, and the charge amount of the toner that passes between the contacting section 562a and the developing roller 510 increases (since it becomes possible for the contacting section 562a to efficiently charge a small amount of toner). As a result, if the distance 1 is modified so as to increase the number associated with the level under the above-described situation, the charge amount and transporting amount in the remanufactured yellow developing device 54 can be adjusted to the appropriate charge amount and appropriate transporting amount, respectively.

In contrast, when the number associated with the level to which another developing roller 510 after replacement belongs is larger than the number associated with the level to which the developing roller 510 before replacement belongs, in other words, the ten-point average roughness Rz of the another developing roller 510 after replacement is smaller than the ten-point average roughness Rz of the developing roller 510 before replacement, the transporting amount of the toner in the remanufactured yellow developing device 54 becomes smaller than the appropriate transporting amount that was suitably adjusted when the yellow developing device 54 was manufactured as a new developing device, etc. Accordingly, the charge amount of the toner that passes between the contacting section 562a and the developing roller 510 in the remanufactured yellow developing device 54 may be larger than the appropriate charge amount that was suitably adjusted when the yellow developing device 54 was manufactured as a new developing device, etc.

If the distance h is modified so as to decrease the number associated with the level, the distance h becomes longer, which reduces the load of the regulating blade 560 with respect to the developing roller 510, and the charge amount of the toner that passes between the contacting section 562a and the developing roller 510 decreases. As a result, if the distance h is modified so as to decrease the number associated with the level under the above-described situation, the charge amount in the remanufactured yellow developing device 54 can be adjusted to the appropriate charge amount. Also, if the distance 1 is modified so as to decrease the number associated with the level, the distance 1 becomes shorter (since the protrusion amount increases), which increases the transporting amount of the toner, and the charge amount of the toner that passes between the contacting section 562a and the developing roller 510 decreases (since it becomes impossible for the contacting section 562a to efficiently charge the toner due to such increase in the transporting amount of the toner). As a result, if the distance 1 is modified so as to decrease the number associated with the level under the above-described situation, the charge amount and transporting amount in the remanufactured yellow developing device 54 can be adjusted to the appropriate charge amount and appropriate transporting amount, respectively.

In addition, in the present working example, the modification extent of the relative position (attachment position) is changed based on to what extent the number associated with the level to which another developing roller 510 after replacement belongs has decreased (increased) compared with the number associated with the level to which the developing roller 510 before replacement belongs. For example, in the case of decrease by one level, one of the distance h and the distance 1 is modified so as to increase the number associated with the level by one. In the case of decrease by two levels, either one of the distance h and the distance 1 is modified so as to increase the number associated with the level by two, or both of the distance h and the distance 1 are modified so as to increase the numbers associated with their levels by one.

Furthermore, in order to perform the above-described modification of relative position (attachment position) smoothly, information regarding a relative position before the relative position is modified is necessary. In the present working example, regulating blade related information that is stored in the developing device-side memory 54a of the yellow developing device 54 is used as such information. That is, the regulating blade related information is relative position information indicating the relative position (attachment position) before that relative position (attachment position) is modified. For example, the regulating blade related information is stored by a manufacturer in a predetermined storing area of the developing device-side memory 54a when the yellow developing device 54 is manufactured as a new developing device (i.e., not as a reused developing device), as the above-described surface roughness information. In the present working example, the information indicating the protrusion amount (namely, a distance 1) and the information indicating the distance (namely, a distance h) are stored in the developing device-side memory 54a as the regulating blade related information.

Description of the method for remanufacturing the yellow developing device 54 is continued going back to the flow chart, assuming that “13” (level 3) and “h2” (level 2) are respectively stored in the developing device-side memory 54a, as the information indicating protrusion amount and the information indicating distance.

When the number associated with the level to which another developing roller 510 after replacement belongs is smaller than the number associated with the level to which the developing roller 510 before replacement belongs (“case B” in step S6), after removal of the regulating blade 560 (step S8), the relative position (attachment position), that is, at least one of the distance h and the distance 1, is modified so as to increase the number associated with the level (step S12). For example, in a case where the level to which the developing roller 510 before replacement belongs is level 3, and the level to which another developing roller 510 after replacement belongs is level 2, the distance 1 is modified from “h2” (level 2) to “h3” (level 3).

Further, when the number associated with the level to which another developing roller 510 after replacement belongs is larger than the number associated with the level to which the developing roller 510 before replacement belongs (“case C” in step S6), after removal of the regulating blade 560 (step S10), the relative position (attachment position), that is, at least one of the distance h and the distance 1 is modified so as to decrease the number associated with the level (step S14). For example, in a case where the level to which the developing roller 510 before replacement belongs is level 2, and the level to which another developing roller 510 after replacement belongs is level 4, the distance 1 is modified from “13” (level 3) to “11” (level 1).

In this way, the regulating blade 560 whose relative position (attachment position) is modified is affixed to the regulating blade supporting sections 526c of the holder 526 with screws, thereby ultimately fixed to the holder 526. After that, another developing roller 510 is attached to the holder 526 to which the regulating blade 560 is fixed, and the holder 526 to which another developing roller 510 is attached is attached to the housing 540, thereby completing reattachment of the regulating blade 560, replacement of the developing roller 510 with another developing roller 510 and the like (reassembly of the yellow developing device 54) (step S16).

Then, the assembled yellow developing device 54 is refilled with toner (step S20), and the yellow developing device 54 is to be remanufactured.

It should be noted that in step S6, if the number associated with the level to which another developing roller 510 after replacement belongs is equal to the number associated with the level to which the developing roller 510 before replacement belongs (“case A” in step S6), the relative position is not modified. In such a case, after the developing roller 510 is replaced with another developing roller 510 (step S18), the yellow developing device 54 is refilled with toner (step S20), and the yellow developing device 54 is to be remanufactured.

As described above, the method for remanufacturing the developing device of this working example includes a step of obtaining the surface roughness value of the developing roller 510 provided in the yellow developing device 54 when the yellow developing device 54 is refilled with toner, and a step of modifying the relative position of the regulating blade 560 with respect to the developing roller 510 based on the obtained value and the surface roughness information stored in the yellow developing device 54. As a result, in cases where the surface roughness of the developing roller 510 provided in the remanufactured yellow developing device 54 is different from the surface roughness of the developing roller 510 when the yellow developing device 54 was manufactured as a new developing device, etc., in reselecting a combination that makes the characteristic favorable, it is not necessary to reselect such a combination from the beginning. Therefore, the procedures to remanufacture the yellow developing device 54 can be simplified.

It should be noted that in step S4 of the foregoing working example, the surface roughness value of another developing roller 510 after replacement is obtained by measuring. However, there is no limitation to this. For example, the surface roughness value may be obtained from materials relating to another developing roller 510 that are separately kept.

However, the foregoing working example is more preferable in that the precise surface roughness values can be obtained.

In addition, in the foregoing working example, the regulating blade related information indicating a relative position before that relative position is modified is stored in the yellow developing device 54, and in the step of modifying the relative position, the relative position is modified using the regulating blade related information. However, there is no limitation to this.

For example, the regulating blade related information may not be stored in the yellow developing device 54, and a relative position before that relative position is modified may be measured and obtained before the regulating blade 560 is removed from the yellow developing device 54 in step S8 and step S10, and the obtained relative position may be used to modify the relative position.

However, the foregoing working example is more preferable in that the procedures involved in the method for remanufacturing the yellow developing device 54 can be simplified.

### REGARDING THE SECOND WORKING EXAMPLE

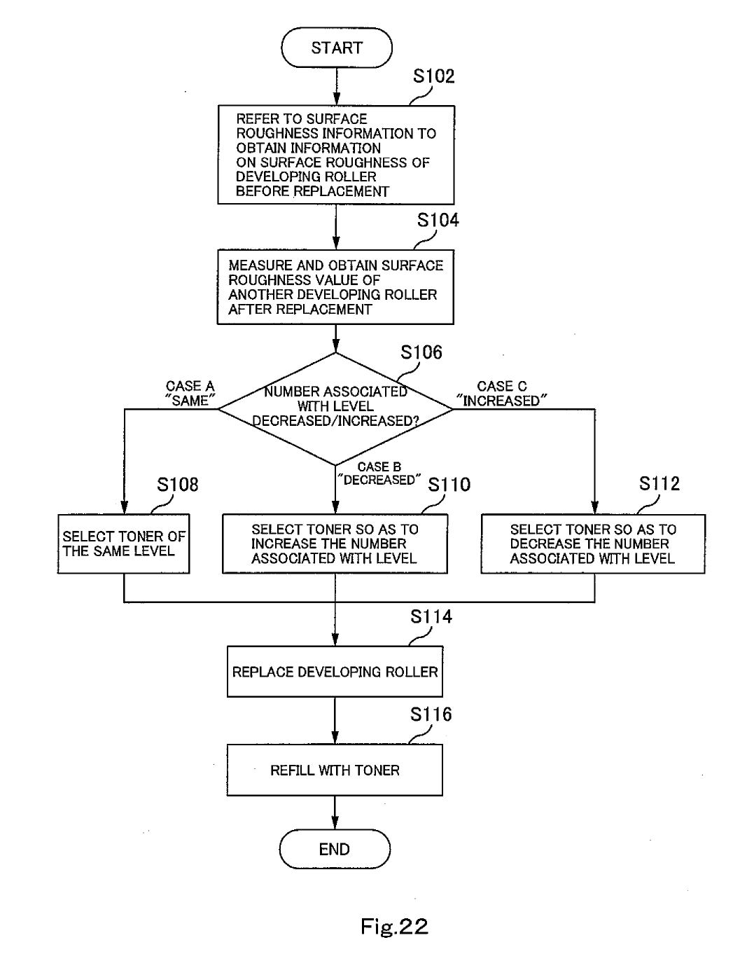

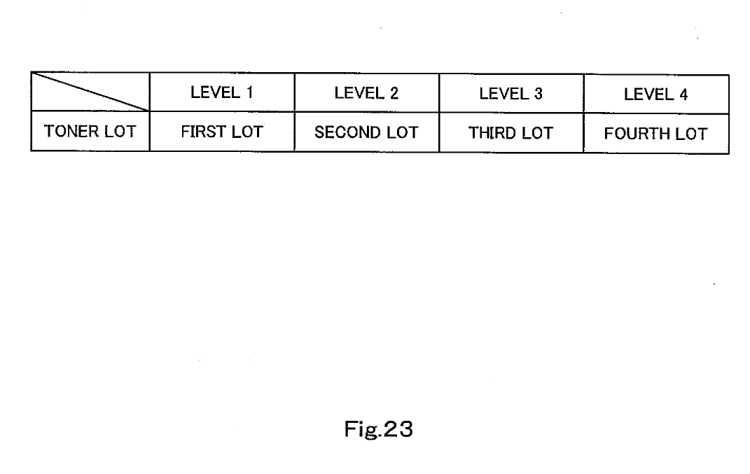

Next, the second working example of the method for remanufacturing the yellow developing device 54 is described with reference to FIGS. 20, 22 and 23. FIG. 22 is a flow chart showing the second working example of the method for remanufacturing the yellow developing device 54. FIG. 23 is a diagram showing four levels of the toner. It should be noted that also in this working example, the developing roller 510 is replaced with another developing roller 510 when remanufacturing the yellow developing device 54.

First, an operator performs the same procedures as step S2 and step S4 of the above-described first working example (step S102 and step S104), and the toner for refilling the yellow developing device 54 is selected based on the surface roughness information obtained in step S102 and the surface roughness value obtained in step S104 (step S106).

Here, the method for selecting the toner for refilling the yellow developing device 54 is described more specifically.

When the yellow developing device 54 is manufactured as a new developing device (i.e., not as a reused developing device), etc., the toner for filling the yellow developing device 54 is selected from among a plurality of types of lots. In the present working example, as shown in FIG. 23, lots of four levels are prepared and the yellow developing device 54 is filled with one of these lots.

When refilling the yellow developing device 54 with toner, the toner for refilling the yellow developing device 54 is selected from among the lots of four levels based on the surface roughness information obtained in step S102 and the surface roughness value obtained in step S104. In selecting the toner, first, it is first determined to which of the four levels shown in FIG. 20 the surface roughness value obtained in step S4 belongs. Then, it is obtained to what extent the number associated with the specified level (namely, the level to which another developing roller 510 after replacement belongs) has decreased (increased) compared with the number associated with the surface roughness information obtained in step S102 (namely, the level to which the developing roller 510 before replacement belongs). If the number associated with the specified level has decreased (increased), the toner for refilling the yellow developing device 54 is selected so as to increase (decrease) the number associated with the level to which the toner for refilling the yellow developing device 54 belongs, compared with the number associated with the level to which the toner that has refilled the yellow developing device 54 before refill with toner belongs.

As mentioned before, when the number associated with the level to which another developing roller 510 after replacement belongs is smaller (larger) than the number associated with the level to which the developing roller 510 before replacement belongs, the transporting amount of the toner in the remanufactured yellow developing device 54 becomes larger (smaller) than the appropriate transporting amount that was suitably adjusted when the yellow developing device 54 was manufactured as a new developing device, etc. Accordingly, the charge amount of the toner that passes between the contacting section 562a and the developing roller 510 in the remanufactured yellow developing device 54 may be lower (higher) than the appropriate charge amount that was suitably adjusted when the yellow developing device 54 was manufactured as a new developing device, etc.

On the other hand, the lots of four levels differ from one another in types or amounts of external additives contained therein, and the transportability and chargeability of the toners vary due to such difference. In this working example, as the number associated with the level increases, the transporting amount of the toner tends to decrease and the charge amount of the toner tends to increase.

Accordingly, when the toner for refilling the yellow developing device 54 is selected in the manner described above, the charge amount and the transporting amount of the remanufactured yellow developing device 54 can be adjusted to the appropriate charge amount and the appropriate transporting amount, respectively.

Also in this working example, when selecting the toner for refilling the yellow developing device 54, it is considered to what extent the number associated with the level to which another developing roller 510 after replacement belongs has decreased (increased) compared with the number associated with the level to which the developing roller 510 before replacement belongs. For example, in the case of decrease by one level, the toner for refilling the yellow developing device 54 is selected so as to increase the number associated with the level to which the toner that refills the yellow developing device 54 belongs by one, compared with the number associated with the level to which the toner that has refilled the developing roller 510 before refill with toner belongs. In case of decrease by two levels, the toner for refilling the yellow developing device 54 is selected so as to increase the number associated with the level to which the toner that refills the yellow developing device 54 belongs by two, compared with the number associated with the level to which the toner that has filled the developing roller 510 before refill with toner belongs.

It should be noted that if the number associated with the level to which another developing roller 510 after replacement belongs is equal to the number associated with the level to which the developing roller 510 before replacement belongs, the lot that is same as the lot of toner that has filled the yellow developing device 54 before refill with toner is selected as the toner for refilling the yellow developing device 54.

Further, in order to perform the above-described selection of the toner smoothly, the information on the toner that has filled the yellow developing device 54 before refill with the toner is necessary. In this working example, the first toner information stored in the developing device-side memory 54a of the yellow developing device 54 is used as the information. Namely, the first toner information is information for specifying the toner that has filled the yellow developing device 54 before refill with toner. For example, the first toner information is stored in a predetermined storing area of the developing device-side memory 54a by a manufacturer when the yellow developing device 54 is manufactured as a new developing device (i.e., not as a reused developing device), as the above-described surface roughness information. In this working example, the lot information of the toner, that is, one of the first lot (level 1) through the fourth lot (level 4), is stored in the developing device-side memory 54a as the toner information.

Description of the method for remanufacturing the yellow developing device 54 is continued going back to the flow chart, assuming that “second lot (level 2)” is stored in the developing device-side memory 54a as the toner information.

If the number associated with the level to which another developing roller 510 after replacement belongs is equal to the number associated with the level to which the developing roller 510 before replacement belongs (“case A” in step S106), the lot of the same type (the same level) as the lot of the toner that has filled the yellow developing device 54 before refill with toner is selected as the toner for refilling the yellow developing device 54 (step S108). Specifically, in this case, the second lot (level 2) is selected.

When the number associated with the level to which another developing roller 510 after replacement belongs is smaller as compared with the number associated with the level to which the developing roller 510 before replacement belongs (“case B” in step S106), the toner for refilling the yellow developing device 54 is selected so as to increase the number associated with the level to which the toner that refills the yellow developing device 54 belongs compared with the number associated with the level to which the toner that has filled the yellow developing device 54 before refill with toner belongs (step S110). For example, in a case where the level to which the developing roller 510 before replacement belongs is level 3, and the level to which another developing roller 510 after replacement belongs is level 1, the fourth lot (level 4) is selected.

When the number associated with the level to which another developing roller 510 after replacement belongs increases compared with the number associated with the level to which the developing roller 510 before replacement belongs (“case C” in step S106), the toner for filling the yellow developing device 54 is selected so as to decrease the number associated with the level to which the toner that refills the yellow developing device 54 belongs compared with the number associated with the level to which the toner that has filled the yellow developing device 54 before refill with toner belongs (step S112). For example, in a case where the level to which the developing roller 510 before replacement belongs is level 2, and the level to which another developing roller 510 after replacement belongs is level 3, the first lot (level 1) is selected.

Then, after the developing roller 510 is replaced with another developing roller 510 (step S114), the yellow developing device 54 is refilled with the toner selected in one of steps S108, S110 or S112 (step S116) to be remanufactured.

As described above, the method for remanufacturing the developing device of this working example includes a step of obtaining the surface roughness value of the developing roller 510 provided in the yellow developing device 54 when the yellow developing device 54 is refilled with toner, and a step of refilling with the toner selected based on the obtained value and the surface roughness information stored in the yellow developing device 54. As a result, in the cases where the surface roughness of the developing roller 510 provided in the remanufactured yellow developing device 54 is different from the surface roughness of the developing roller 510 when the yellow developing device 54 was manufactured as a new developing device, etc., in reselecting a combination that makes the characteristic favorable, it is not necessary to reselect such a combination from the beginning. Therefore, the procedure to remanufacture the yellow developing device 54 can be simplified.

Further, in the foregoing working example, the first toner information that specifies the toner that has filled the yellow developing device 54 before the toner is refilled is stored in the yellow developing device 54, and in the step of refilling with the toner, the toner for refilling the yellow developing device 54 is selected based on the first toner information. However, there is no limitation to this.

For example, the first toner information may not be stored in the yellow developing device 54, and the information that specifies the toner that has filled the yellow developing device 54 before refill with toner may be obtained from materials relating to the toner that are separately kept, and the obtained information may be used to select the toner for refilling the yellow developing device 54.

However, the foregoing working example is more preferable in that that procedures involved in the method for remanufacturing the yellow developing device 54 can be simplified.

### REGARDING THE THIRD WORKING EXAMPLE

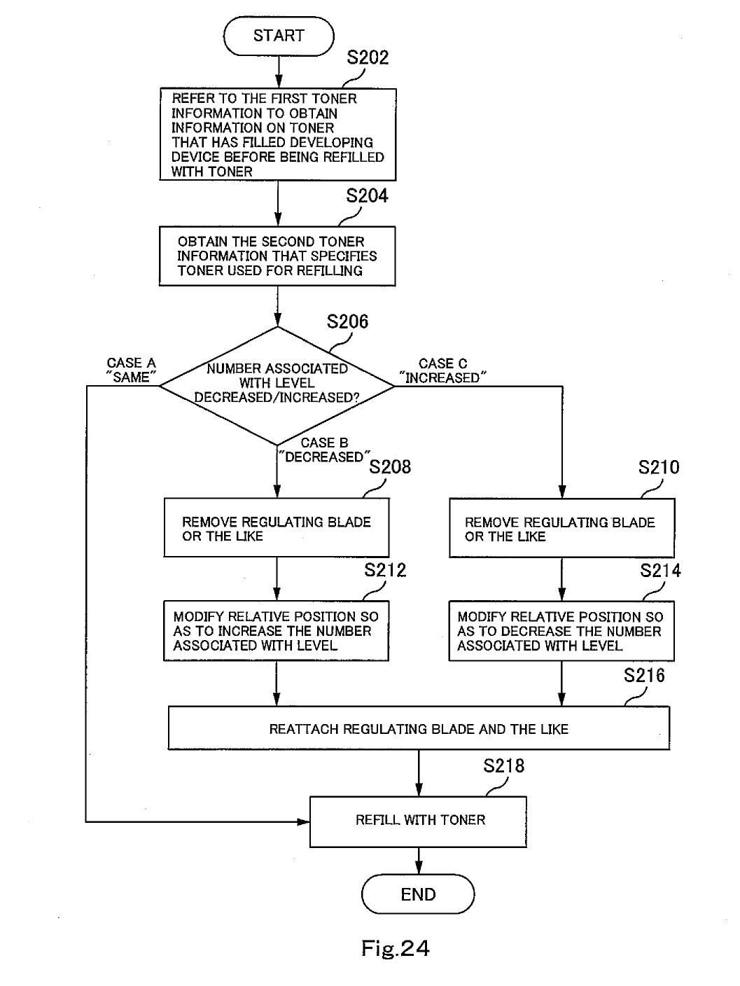

Next, the third working example of the method for remanufacturing the yellow developing device 54 is described with reference to FIGS. 19, 21, 23, and 24. FIG. 24 is a flowchart showing the third working example of the method for remanufacturing the yellow developing device 54. It should be noted that while the developing roller 510 provided in the yellow developing device 54 wears as the yellow developing device 54 is used, in this working example, of the yellow developing devices 54 collected by suppliers or the like of the yellow developing device 54, only yellow developing devices 54 with a light degree of wear are subject to remanufacturing.

First, an operator refers to the above-described first toner information that is stored in the developing device-side memory 54a of the yellow developing device 54, and obtains the information relating to the toner that has been filled in the yellow developing device 54 before refill with toner (step S202). In other words, the lot of the toner (the level to which the toner belongs) is obtained.

Next, the operator obtains the second toner information that specifies the toner used for refilling (step S204). In this working example, the information on the lot of the toner (the level to which the toner belongs) is obtained from materials relating to the toner that are separately kept.

Subsequently, the operator modifies the relative position of the regulating blade 560 with respect to the developing roller 510 based on the first toner information obtained in step S202 and the second toner information obtained in step S204 (“case B” and “case C” in step S206).

In such a case, first, following procedures are carried out in order to facilitate the modification. That is, first, the yellow developing device 54 is taken apart into the holder 526 to which the regulating blade 560 and the developing roller 510 are attached, and the housing 540. Next, the developing roller 510 is removed from the holder 526. Then, the regulating blade 560 is removed from the holder 526 from which the developing roller 510 has been removed (step S208 and step S210).

Subsequently, the procedure for reattaching a regulating blade 560 (namely, the regulating blade 560 shown in FIG. 5) to the holder 526 from which that regulating blade 560 has been removed (namely, the holder 526 shown in FIG. 6) is carried out. During the attachment, the attachment position of the regulating blade 560 with respect to the holder 526 is modified (in other words, the relative position of the regulating blade 560 with respect to the developing roller 510 is modified).

Here, the method for modifying the attachment position (relative position) is described. When modifying the attachment position, first, it is determined to what extent the number associated with the second toner information (namely, the level to which the toner that refills the yellow developing device 54 belongs) has decreased (increased), compared with the number associated with the first toner information (namely, the level to which the toner that has filled the yellow developing device 54 before refill with toner belongs). When the number associated with the specified level has decreased (increased), at least one of the above-described distance h and distance 1 is modified to the opposite manner, that is, in the manner to increase (decrease) the number associated with the levels shown in FIG. 20.

As described above, lots of four levels are prepared for toner, and as the number associated with the level increases, the transporting amount of the toner tends to decrease and the charge amount of the toner tends to increase. Therefore, when the number associated with the level to which the toner that refills the yellow developing device 54 belongs is smaller than the number associated with the level to which the toner that has filled the yellow developing device 54 before refill with toner belongs, the transporting amount of the toner in the remanufactured yellow developing device 54 becomes larger than the appropriate transporting amount that was suitably adjusted when the yellow developing device 54 was manufactured as a new developing device, etc. Accordingly, the charge amount of the toner that passes between the contacting section 562a and the developing roller 510 in the remanufactured yellow developing device 54 may be lower than the appropriate charge amount that was suitably adjusted when the yellow developing device 54 was manufactured as a new developing device, and the like.

If the distance h is modified so as to increase the number associated with the level, the distance h becomes shorter, which increases the load of the regulating blade 560 with respect to the developing roller 510, and the charge amount of the toner that passes between the contacting section 562a and the developing roller 510 increases. As a result, if the distance h is modified so as to increase the number associated with the level under the above-described situation, the charge amount in the remanufactured yellow developing device 54 can be adjusted to the appropriate charge amount. Also, if the distance 1 is modified so as to increase the number associated with the level, the distance 1 becomes longer (the protrusion amount decreases), which reduces the transporting amount of the toner, and the charge amount of the toner that passes between the contacting section 562a and the developing roller 510 increases (since it becomes possible for the contacting section 562a to efficiently charge a small amount of toner). As a result, if the distance 1 is modified so as to increase the number associated with the level under the above-described situation, the charge amount and the transporting amount in the remanufactured yellow developing device 54 can be adjusted to the appropriate charge amount and appropriate transporting amount, respectively.

In contrast, when the number associated with the level to which the toner that refills the yellow developing device 54 belongs increases compared with the number associated with the level to which the toner that has filled the yellow developing device 54 before refill with toner belongs, the transporting amount of the toner in the remanufactured yellow developing device 54 becomes smaller than the appropriate transporting amount that was suitably adjusted when the yellow developing device 54 was manufactured as a new developing device, and the like. Accordingly, the charge amount of the toner that passes between the contacting section 562a and the developing roller 510 in the remanufactured yellow developing device 54 may be larger than the appropriate charge amount that was suitably adjusted when the yellow developing device 54 was manufactured as a new developing device, or the like.

If the distance h is modified so as to decrease the number associated with the level, the distance h becomes longer, which reduces the load of the regulating blade 560 with respect to the developing roller 510, and the charge amount of the toner that passes between the contacting section 562a and the developing roller 510 decreases. As a result, when the distance h is modified so as to decrease the number associated with the level under the above-described situation, the charge amount in the remanufactured yellow developing device 54 can be adjusted to the appropriate charge amount. Also, when the distance 1 is modified so as to decrease the number associated with the level, the distance 1 becomes shorter (since the protrusion amount increases), which increases the transporting amount of the toner, and the charge amount of the toner that passes between the contacting section 562a and the developing roller 510 decreases (since it becomes impossible for the contacting section 562a to efficiently charge toner due to such increase in the transporting amount of the toner). As a result, if the distance 1 is modified so as to decrease the number associated with the level under the above-described situation, the charge amount and transporting amount in the remanufactured yellow developing device 54 can be adjusted to the appropriate charge amount and appropriate transporting amount, respectively.

In addition, in this working example, the modification extent of the relative position (attachment position) is changed based on to what extent the number associated with the level to which the toner that refills the yellow developing device 54 belongs has decreased (increased) compared with the number associated with the level to which the toner that has filled the yellow developing device 54 before refill with toner belongs. For example, in case of decrease by one level, one of the distance h and the distance 1 is modified so as to increase the number associated with the level by one. In case of decrease by two levels, one of the distance h and the distance 1 is modified so as to increase the number associated with the level by two, or both of the distance h and the distance 1 are modified so as to increase the numbers associated with their levels by one.

Furthermore, in order to perform the above-described modification of relative position (attachment position) smoothly, information regarding a relative position before that relative position is modified is necessary. In this working example, the information indicating the protrusion amount (namely, distance 1) and the information indicating the distance (namely, distance h) that are stored in the developing device-side memory 54a of the yellow developing device 54 are used as such information.

Description of the method for remanufacturing the yellow developing device 54 is continued going back to the flow chart, assuming that “13” (level 3) and “h2” (level 2) are respectively stored as the information indicating the protrusion amount and the information indicating the distance in the developing device-side memory 54a.

When the number associated with the level to which the toner that refills the yellow developing device 54 belongs is smaller as compared with the number associated with the level to which the toner that has filled the yellow developing device 54 before refill with toner belongs (“case B” in step S206), after removal of the regulating blade 560 (step S208), the relative position (attachment position), that is, at least one of the distance h and the distance 1, is modified so as to increase the number associated with the level (step S212). For example, in a case where the level to which the toner that has filled the yellow developing device 54 before refilling the toner belongs is level 3, and the level to which the toner that refills the yellow developing device 54 belongs is level 2, the distance 1 is modified from “h2” (level 2) to “h3” (level 3).

When the number associated with the level to which the toner that refills the yellow developing device 54 belongs is larger as compared with the number associated with the level to which the toner that has filled the yellow developing device 54 before refill with toner belongs (“case Cr” in step S206), after removal of the regulating blade 560 (step S210), the relative position (attachment position), that is, at least one of the distance h and the distance 1, is modified so as to decrease the number associated with the level (step S214). For example, in a case where the level to which the toner that has filled the yellow developing device 54 before refill with toner belongs is level 2, and the level to which the toner that refills the yellow developing device 54 belongs is level 4, the distance 1 is modified from “13” (level 3) to “11” (level 1).

In this way, the regulating blade 560 whose relative position (attachment position) is modified is affixed to the regulating blade supporting sections 526c of the holder 526 with screws, thereby ultimately fixed to the holder 526. After that, the developing roller 510 is reattached to the holder 526 to which the regulating blade 560 is fixed. The holder 526 to which the developing roller 510 is attached is attached to the housing 540, thereby completing reattachment of the regulating blade 560 and the like (reassembly of the yellow developing device 54) (step S216).

Then, the assembled yellow developing device 54 is refilled with toner (step S218) and the yellow developing device 54 is to be remanufactured.

It should be noted that in step S206, if the number associated with the level to which the toner that refills the yellow developing device 54 belongs is equal to the number associated with the level to which the toner that has filled the yellow developing device 54 before refill with toner belongs (“case A” in step S206), the relative position is not modified. In such a case, the yellow developing device 54 is refilled with toner (step S218) and the yellow developing device 54 is to be remanufactured without modifying the relative position.

As described above, the method for remanufacturing the developing device of this working example includes a step of obtaining the second toner information that specifies the toner used for refilling, and a step of modifying the relative position of the regulating blade 560 with respect to the developing roller 510 based on the first toner information stored in the yellow developing device 54 and the obtained second toner information. As a result, in the cases where the lot of the toner used for refilling is different from the lot of the toner that has filled the yellow developing device 54 when it was manufactured as a new developing device, and the like, in reselecting a combination that makes the characteristic favorable, it is not necessary to reselect such a combination from the beginning. Therefore, the procedure to remanufacture the yellow developing device 54 can be simplified.

### REGARDING THE FOURTH WORKING EXAMPLE

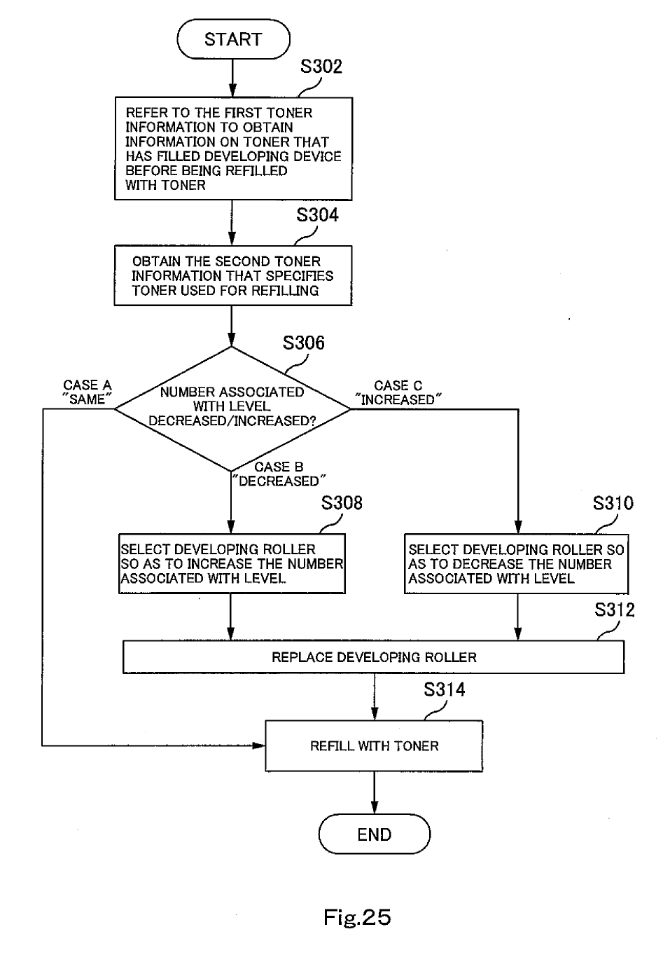

Next, the fourth working example of the method for remanufacturing the yellow developing device 54 is described with reference to FIGS. 20, 23, and 25. FIG. 25 is a flow chart showing the fourth working example regarding the method for remanufacturing the yellow developing device 54. It should be noted that also in this working example, of the yellow developing devices 54 collected by suppliers or the like of the same, only yellow developing devices 54 with a light degree of wear are subject to remanufacturing.

First, an operator performs the same procedures as step S202 and step S204 of the above-described third working example (step S302 and step S304), and the developing roller 510 is replaced with another developing roller 510 selected from among a plurality of developing rollers 510 that mutually have different surface roughness based on the first toner information obtained in step S302 and the second toner information obtained in step S304 (“case B” and “case C” in step S306).

Here, the method for replacing the developing roller 510 with another developing roller 510 is described. When replacing the developing roller 510 with another developing roller 510, first, it is determined to what extent the number associated with the second toner information (namely, the level to which the toner that refills the yellow developing device 54 belongs) has decreased (increased) as compared with the number associated with the first toner information (namely, the level to which the toner that has filled the yellow developing device 54 before refilling with toner belongs). If the number associated with the specified level has decreased (increased), the developing roller 510 is replaced so as to increase (decrease) the number associated with the level to which another developing roller 510 after replacement belongs, as compared with the number associated with the level to which the developing roller 510 before replacement belongs.

As described above, the lots of four levels are prepared for toner. As the number associated with the level increases, the transporting amount of the toner tends to decrease and the charge amount of the toner tends to increase. Therefore, when the number associated with the level to which the toner that refills the yellow developing device 54 belongs is smaller (larger) as compared with the number associated with the level to which the toner that has filled the yellow developing device 54 before refill with toner belongs, the transporting amount of the toner in the remanufactured yellow developing device 54 becomes larger (smaller) than the appropriate transporting amount that was suitably adjusted when the yellow developing device 54 was manufactured as a new developing device, and the like. Accordingly, the charge amount of the toner that passes between the contacting section 562a and the developing roller 510 in the remanufactured yellow developing device 54 may be lower (higher) than the appropriate charge amount that was suitably adjusted when the yellow developing device 54 was manufactured as a new developing device, and the like.

When the developing roller 510 is replaced so as to increase (decrease) the number associated with the level to which another developing roller 510 after replacement belongs, as compared with the number associated with the level to which the developing roller 510 before replacement belongs, the ten-point average roughness Rz of the developing roller 510 after replacement is smaller (larger) than the ten-point average roughness Rz of the developing roller 510 before replacement, which reduces (increase) the transporting amount of the toner, and the charge amount of the toner that passes between the contacting section 562a and the developing roller 510 increases (decreases). Accordingly, when the developing roller 510 is replaced so as to increase (decrease) the number associated with the level to which another developing roller 510 after replacement belongs, as compared with the number associated with the level to which the developing roller 510 before replacement belongs, in the above case, the charge amount and transporting amount in the remanufactured yellow developing device 54 can be adjusted to the appropriate charge amount and appropriate transporting amount, respectively.

Also in this working example, in selecting another developing roller 510, it is considered to what extent the number associated with the level to which the toner that refills the yellow developing device 54 belongs has decreased (increased), as compared with the number associated with the level to which the toner that has filled the yellow developing device 54 before refill with toner belongs. For example, in the case of decrease by one level, another developing roller 510 is selected so as to increase the number associated with the level to which another developing roller 560 after replacement by one, as compared with the number associated with the level to which the developing roller 560 before replacement belongs. In the case of decrease by two levels, another developing device is selected so as to increase the number associated with the level to which another developing device 510 after replacement belongs by two, as compared with the number associated with the level to which the developing roller 510 before replacement belongs.

In order to perform the above-described replacement of the developing roller 510 smoothly, information on the surface roughness of the developing roller 510 before replacement is necessary. In this working example, the above-described surface roughness information stored in the developing device-side memory 54a of the yellow developing device 54 is used as such information.

Description of the method for remanufacturing the yellow developing device 54 is continued going back to the flow chart, assuming that level 2 is stored in the developing device-side memory 54a as the surface roughness information.

In the case where the number associated with the level to which the toner that refills the yellow developing device 54 belongs is smaller than the number associated with the level to which the toner that has filled the yellow developing device 54 before refill with toner belongs (“case B” in step S306), another developing roller 510 is selected so as to increase the number associated with the level to which another developing roller 510 after replacement belongs, compared with the number associated with the level to which the developing roller 510 before replacement belongs (step S308). For example, in the case where the level to which the toner that has filled the yellow developing device 54 before refill with toner belongs is level 3, and the level to which the toner that refills the yellow developing device 54 belongs is level 1, another developing roller 510 that belongs to level 4 is selected.

Further, when the number associated with the level to which the toner that refills the yellow developing device 54 belongs is larger than the number associated with the level to which the toner that has filled the yellow developing device 54 before refill with the toner belongs (“case C” in step S306), another developing roller 510 is selected so as to decrease the number associated with the level to which another developing roller 510 after replacement belongs, as compared with the number associated with the level to which the developing roller 510 before replacement belongs (step S310). For example, in the case where the level to which the toner that has filled the yellow developing device 54 before refill with toner belongs is level 2, and the level to which the toner that refills the yellow developing device 54 belongs is level 3, another developing roller 510 that belongs to level 1 is selected.

Then, in order to replace the developing roller 510 with the selected another developing roller 510, first, the yellow developing device 54 is taken apart into the holder 526 to which the developing roller 510 is attached, and the housing 540. Next, the developing roller 510 is removed from the holder 526. Then, the developing roller 510 that is selected in step S308 or step S310 is attached to the holder 526. Further, the holder 526 to which the developing roller 510 is attached is attached to the housing 540, thereby completing reassembly of the yellow developing device 54 (replacement of the developing roller 510) (step S312).

Then, the assembled yellow developing device 54 is refilled with toner (step S314), and the yellow developing device 54 is to be remanufactured.

It should be noted that in step S306, when the number associated with the level to which the toner that refills the yellow developing device 54 belongs is equal to the number associated with the level to which the toner that has filled the yellow developing device 54 before refill with toner belongs (“case A” in step S6), the developing roller 510 is not replaced. In such a case, the yellow developing device 54 is refilled with the toner (step S314) and the yellow developing device 54 is remanufactured without replacing the developing roller 510 with another developing roller 510.

As described above, the method for remanufacturing the developing device of this working example includes a step of obtaining the second toner information that specifies the toner used for refilling, and a step of replacing the developing roller 510 with another developing roller 510 selected from among a plurality of the developing rollers 510 that mutually have different surface roughness based on the first toner information stored in the yellow developing device 54 and the obtained second toner information. As a result, in cases where the lot of the toner used for refilling is different from the lot of the toner that has filled the yellow developing device 54 when it was manufactured as a new developing device, and the like, in reselecting a combination that makes the characteristic favorable, it is not necessary to reselect the combination from the beginning. Therefore, the procedure of remanufacturing the yellow developing device 54 can be simplified.

Also in the foregoing working example, the surface roughness information indicating the surface roughness of the developing roller 510 that has been provided in the yellow developing device 54 before replacement thereof that is the surface roughness information when the developing roller 510 was attached to the yellow developing device 54 is stored in the yellow developing device 54. In the step of replacing the developing roller 510 with another developing roller 510, another developing roller 510 is selected from among a plurality of developing rollers 510 that mutually have different surface roughness based on the surface roughness information. However, there is no limitation to this.

For example, the surface roughness information may not be stored in the yellow developing device 54, and information on the surface roughness of the developing roller 510 provided in the yellow developing device 54 before replacement thereof may be obtained from materials relating to the developing roller 510 that are separately kept, and the obtained surface roughness may be used to select another developing device 510.

However, the foregoing working example is more preferable in that procedures involved in the method for remanufacturing the yellow developing device 54 can be simplified.

### OTHER EMBODIMENTS ACCORDING TO THE THIRD EMBODIMENT

The method for remanufacturing developing units according to this invention was described above based on the foregoing third embodiment. However, the foregoing embodiment of the invention is for the purpose of elucidating the present invention and is not to be interpreted as limiting the present invention. The invention can of course be altered and improved without departing from the gist thereof and includes functional equivalents.

It should be noted that in the foregoing embodiment, an intermediate image transfer type full-color laser beam printer was described as an example of the image forming apparatus, however, the present invention can also be adopted for various types of image forming apparatuses, such as full-color laser beam printers other than the intermediate image transfer type, monochrome laser beam printers, copying machines, and facsimiles.

Furthermore, the photosensitive body may not be limited to a so-called photodetection roller, configured by providing a photosensitive layer to an outer circumference surface of a cylindrical conductive material, but may be a so-called photodetection belt configured by providing a photosensitive layer on a surface of a belt-type conductive material.

Furthermore, in the foregoing embodiment, four working examples are described as examples of the method for remanufacturing developing devices. However, they may be adopted in combination. For example, if the number associated with the level to which the developing roller 510 after replacement belongs decreases by two compared with the number associated with the level to which the developing roller 510 before replacement belongs, the toner for refilling the yellow developing device 54 may be selected so as to increase the number associated with the level to which the toner that refills the yellow developing device 54 belongs by one, compared with the number associated with the level to which the toner that has filled the yellow developing device 54 before refill with toner belongs, and further, one of the above-described distance h and the distance 1 may be modified so as to increase the number associated with the level by one.

Also, in the first and second working examples, the developing roller 510 is replaced with another developing roller 510 when remanufacturing the yellow developing device 54. However, there is no limitation to this, and the developing roller 510 may not be replaced. In such a case, subsequent steps are carried out after the surface roughness value of the developing roller 510 provided in the collected developing device is measured and obtained in step S104 or step S204.

Furthermore, in the foregoing embodiment, the regulating blade related information, the surface roughness information and the toner information are stored in the developing device-side memories 51a, 52a, 53a, and 54a provided to the developing device. However, there is no limitation to this. For example, such information may be written on the developing device using writing instruments, stamps, and the like. However, the foregoing embodiment is more preferable in terms of avoiding soiling of the developing device.

===Configuration of Image Forming System, Etc.===

Next, an embodiment of an image forming system serving as an example of an embodiment of the present invention is described with reference to the drawings.

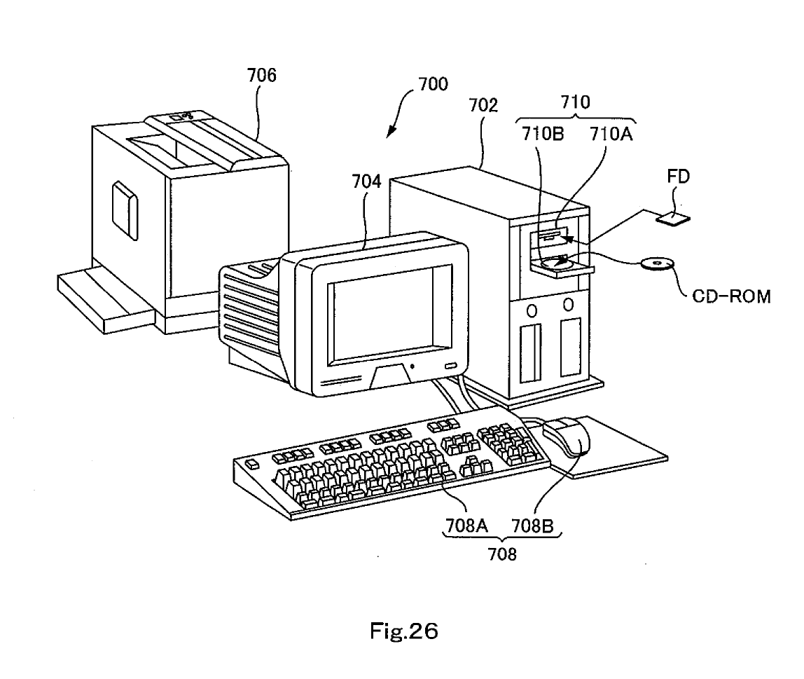

FIG. 26 is an explanatory diagram describing an external configuration of the image forming system. An image forming system 700 is provided with a computer 702, a display device 704, a printer 706, an input device 708, and a reading device 710. In this embodiment, the computer 702 is accommodated within a mini-tower type housing. However, there is no limitation to this. A CRT (cathode ray tube), a plasma display, a liquid crystal display device and the like are generally used as the display device 704, however there is no limitation to this. The printer described above is used as the printer 706. In this embodiment, a keyboard 708A and a mouse 708B are used as the input device 708, however, there is no limitation to these. In this embodiment, a flexible disk drive unit 710A and a CD-ROM drive unit 710B are used as the reading device 710, however there is no limitation to this, and it may also be, for example, a MO (Magnet Optical), a disk drive device, a DVD (Digital Versatile Disk) and the like.

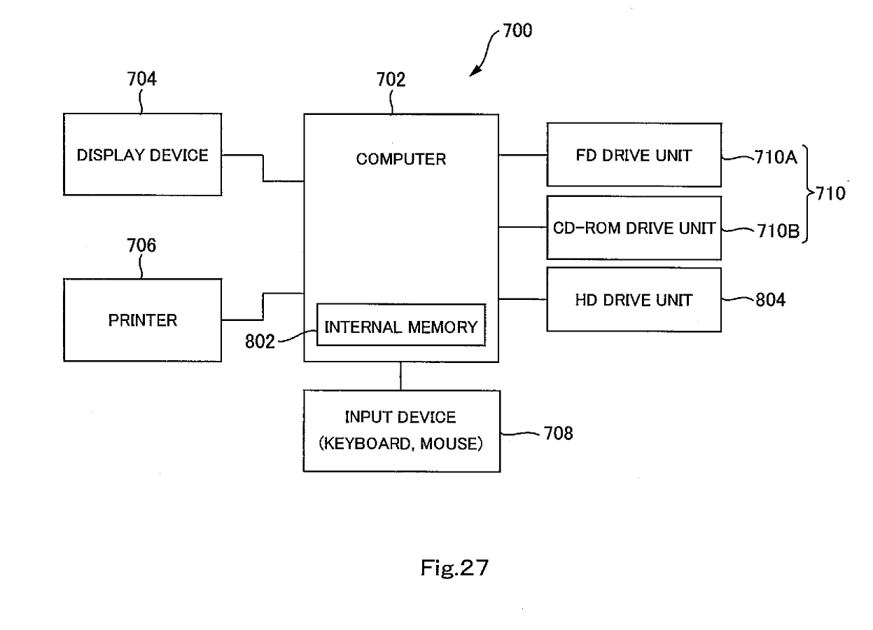

FIG. 27 is a block diagram showing a configuration of the image forming system shown in FIG. 26. Within the housing accommodating the computer 702, an internal memory 802 such as a RAM, and also an external memory such as a hard disk drive unit 804 are provided.

Further, in the above description, an example was described in which the image forming system is constituted by connecting the printer 706 to the computer 702, the display device 704, the input device 708, and the reading device 710, however there is no limitation to this. For example, the image forming system can be made of the computer 702 and the printer 706, and the image forming system does not have to be provided with all of the display device 704, the input device 708, and the reading device 710.

Further, for example, the printer 706 may have some of the functions or mechanisms of the computer 702, the display device 704, the input device 708, and the reading device 710. For example, the printer 706 may be configured so as to have an image processing section for carrying out image processing, a display section for carrying out various types of displays, and a recording media attachment/detachment section to and from which the recording media storing image data captured by a digital camera or the like are inserted and taken out.

As an overall system, the image forming system that is thus achieved is superior to conventional systems.

1. A method for reattaching a layer thickness regulating member comprising:
a step of removing the layer thickness regulating member from a developing device provided with the layer thickness regulating member, for regulating a layer thickness of a developer borne on a developer bearing body, that contacts the developer bearing body at a contacting section;
a step of adjusting a length, of the layer thickness regulating member to be reattached to the developing device, from a front end of the layer thickness regulating member to the contacting section, based on information that is stored in the developing device and indicates the length; and
a step of reattaching the layer thickness regulating member for which the length is adjusted to the developing device.

2. A method for reattaching a layer thickness regulating member according to claim 1,
wherein the layer thickness regulating member includes a contacting member that contacts the developer bearing body and a supporting member for supporting at its one end portion the contacting member,
wherein the method includes a step of adjusting a distance of the layer thickness regulating member to be reattached to the developing device from a reference position to the other end portion of the supporting member in a direction from the contacting member toward the developer bearing body, based on information that is stored in the developing device and indicates the distance, and
wherein in the step of reattaching the layer thickness regulating member to the developing device, the layer thickness regulating member for which the distance and the length are adjusted is reattached to the developing device.

3. A method for reattaching a layer thickness regulating member according to claim 2,
wherein in the step of adjusting the distance, the distance of the layer thickness regulating member reattached to the developing device is adjusted, based on information that is stored in the developing device and indicates a thickness of the contacting member.

4. A method for reattaching a layer thickness regulating member according to claim 1,
wherein the information is stored in a storage element provided to the developing device.

5. A method for reattaching a layer thickness regulating member comprising:
a step of removing the layer thickness regulating member from a developing device provided with the layer thickness regulating member, for regulating a layer thickness of a developer borne on a developer bearing body, that contacts the developer bearing body at a contacting section;
a step of adjusting a length, of the layer thickness regulating member to be reattached to the developing device, from a front end of the layer thickness regulating member to the contacting section, based on information that is stored in the developing device and indicates the length;
a step of reattaching the layer thickness regulating member for which the length is adjusted to the developing device; and
a step of adjusting a distance of the layer thickness regulating member to be reattached to the developing device from a reference position to the other end portion of a supporting member provided in the layer thickness regulating member for supporting at its one end portion a contacting member, in a direction from the contacting member that is provided in the layer thickness regulating member and contacts the developer bearing body toward the developer bearing body, based on information that is stored in the developing device and indicates the distance,
wherein
in the step of reattaching the layer thickness regulating member to the developing device, the layer thickness regulating member for which the distance and the length are adjusted is reattached to the developing device,
in the step of adjusting the distance, the distance of the layer thickness regulating member reattached to the developing device is adjusted, based on information that is stored in the developing device and indicates a thickness of the contacting member, and
the information is stored in a storage element provided to the developing device.

6. A developing device comprising:
a developer bearing body for bearing a developer;
a layer thickness regulating member, for regulating a layer thickness of a developer borne on the developer bearing body, that contacts the developer bearing body at a contacting section; and
information that indicates a length from a front end of the layer thickness regulating member to the contacting section.

7. A developing device according to claim 6,
wherein the layer thickness regulating member includes a contacting member that contacts the developer bearing body and a supporting member for supporting at its one end portion the contacting member, and
wherein the developing device has information that indicates a distance from a reference position to the other end portion of the supporting member in a direction from the contacting member toward the developer bearing body.

8. A developing device according to claim 7, comprising:
information that indicates a thickness of the contacting member.

9. A developing device according to claim 6,
wherein the information is stored in a storage element provided to the developing device.

10. A developing device comprising:
a developer bearing body for bearing a developer;
a layer thickness regulating member, for regulating a layer thickness of a developer borne on the developer bearing body, that contacts the developer bearing body at a contacting section;
information that indicates a length from a front end of the layer thickness regulating member to the contacting section;
information that indicates a distance from a reference position to the other end portion of a supporting member provided in the layer thickness regulating member for supporting at its one end portion a contacting member, in a direction from the contacting member that is provided in the layer thickness regulating member and contacts the developer bearing body toward the developer bearing body; and
information that indicates a thickness of the contacting member,
wherein the information is stored in a storage element provided to the developing device.

11. An image forming apparatus comprising:
a developing device including a developer bearing body for bearing a developer, a layer thickness regulating member, for regulating a layer thickness of a developer borne on the developer bearing body, that contacts the developer bearing body at a contacting section, and information that indicates a length from a front end of the layer thickness regulating member to the contacting section.

12. An image forming system comprising:
a computer; and
an image forming apparatus that can be connected to the computer, the image forming apparatus including a developing device that has a developer bearing body for bearing a developer, a layer thickness regulating member, for regulating a layer thickness of a developer borne on the developer bearing body, that contacts the developer bearing body at a contacting section, and information that indicates a length from a front end of the layer thickness regulating member to the contacting section.

13. A method for remanufacturing a developing device, comprising:
a step of refilling with a developer a developing device provided with a developer bearing body for bearing a developer and a layer thickness regulating member, for regulating a layer thickness of a developer borne on the developer bearing body, that contacts the developer bearing body at a contacting section; and
a step of modifying a relative position when it is determined to modify the relative position, by determining whether or not to modify the relative position of the layer thickness regulating member with respect to the developer bearing body, based on data that is actually measured after the developer bearing body and the layer thickness regulating member are attached to the developing device and stored in the developing device, and indicates a characteristic of a developer that has passed between the contacting section and the developer bearing body.

14. A method for remanufacturing a developing device according to claim 13,
wherein in the step of modifying the relative position,
a modification extent of the relative position is changed based on the data.

15. A method for remanufacturing a developing device according to claim 13,
wherein relative position information that indicates the relative position before the relative position is modified is stored in the developing device, and
wherein in the step of modifying the relative position,
the relative position is modified using the relative position information.

16. A method for remanufacturing a developing device according to claim 15,
wherein the relative position information is information that indicates a length from a front end of the layer thickness regulating member to the contacting section, and
wherein in the step of modifying the relative position,
the length is modified using the information indicating the length.

17. A method for remanufacturing a developing device according to claim 15,
wherein the layer thickness regulating member includes a contacting member that contacts the developer bearing body and a supporting member for supporting at its one end portion the contacting member,
wherein the relative position information is information that indicates a distance from a reference position to the other end portion of the supporting member in a direction from the contacting member toward the developer bearing body, and
wherein in the step of modifying the relative position,
the distance is modified using the information indicating the distance.

18. A method for remanufacturing a developing device comprising:
a step of refilling with a developer a developing device provided with a developer bearing body for bearing a developer and a layer thickness regulating member, for regulating a layer thickness of a developer borne on the developer bearing body, that contacts the developer bearing body at a contacting section; and
a step of replacing the developer bearing body with another developer bearing body when it is determined to replace the developer bearing body, by determining whether or not to replace the developer bearing body with the another developer bearing body, based on data that is actually measured after the developer bearing body and the layer thickness regulating member are attached to the developing device and stored in the developing device, and indicates a characteristic of a developer that has passed between the contacting section and the developer bearing body.

19. A method for remanufacturing a developing device according to claim 18,
wherein in the step of replacing the developer bearing body with the another developer bearing body,
the another developer bearing body is selected from among a plurality of developer bearing bodies that mutually have different surface roughness, based on the data.

20. A method for remanufacturing a developing device according to claim 18,
wherein surface roughness information, that indicates surface roughness of a developer bearing body that has been provided in the developing device before replacement of the developer bearing body, and that is surface roughness when the developer bearing body has been attached to the developing device, is stored in the developing device, and
wherein in the step of replacing the developer bearing body with the another developer bearing body,
the another developer bearing body is selected from among a plurality of developer bearing bodies that mutually have different surface roughness, using the surface roughness information.

21. A method for remanufacturing a developing device comprising:
a step of refilling with a developer a developing device provided with a developer bearing body for bearing a developer and a layer thickness regulating member, for regulating a layer thickness of a developer borne on the developer bearing body, that contacts the developer bearing body at a contacting section,
wherein in the step,
a developer selected based on data, that is actually measured after the developer bearing body and the layer thickness regulating member are attached to the developing device and stored in the developing device, and indicates a characteristic of a developer that has passed between the contacting section and the developer bearing body, is used for refilling.

22. A method for remanufacturing a developing device according to claim 21,
wherein developer information that specifies a developer that has filled the developing device before being refilled with a developer is stored in the developing device, and
wherein in the step,
a developer for refilling the developing device is selected using the developer information.

23. A method for remanufacturing a developing device according to claim 13,
wherein the data is stored in a storage element provided to the developing device.

24. A method for remanufacturing a developing device, comprising:
a step of refilling with a developer a developing device provided with a developer bearing body for bearing a developer and a layer thickness regulating member, for regulating a layer thickness of a developer borne on the developer bearing body, that contacts the developer bearing body at a contacting section; and
a step of modifying a relative position when it is determined to modify the relative position, by determining whether or not to modify the relative position of the layer thickness regulating member with respect to the developer bearing body, based on data that is actually measured after the developer bearing body and the layer thickness regulating member are attached to the developing device and stored in the developing device, and indicates a characteristic of a developer that has passed between the contacting section and the developer bearing body,
wherein in the step of modifying the relative position,
a modification extent of the relative position is changed based on the data,
wherein relative position information that indicates a relative position before the relative position is modified is stored in the developing device,
wherein in the step of modifying the relative position,
the relative position is modified using the relative position information,
wherein the relative position information is information that indicates a length from a front end of the layer thickness regulating member to the contacting section,
wherein in the step of modifying the relative position,
the length is modified using the information indicating the length,
the layer thickness regulating member includes a contacting member that contacts the developer bearing body and a supporting member for supporting at its one end portion the contacting member,
wherein the relative position information is information that indicates a distance from a reference position to the other end portion of the supporting member in a direction from the contacting member toward the developer bearing body,
wherein in the step of modifying the relative position,
the distance is modified using the information indicating the distance, and
the data is stored in a storage element provided to the developing device.

25. A developing device comprising:
a developer bearing body for bearing a developer;
a layer thickness regulating member, for regulating a layer thickness of a developer borne on the developer bearing body, that contacts the developer bearing body at a contacting section; and
a storage element for storing data that is actually measured after the developer bearing body and the layer thickness regulating member are attached to the developing device, and indicates a characteristic of a developer that has passed between the contacting section and the developer bearing body.

26. An image forming apparatus comprising:
a developing device having a developer bearing body for bearing a developer, a layer thickness regulating member, for regulating a layer thickness of a developer borne on the developer bearing body, that contacts the developer bearing body at a contacting section, and a storage element for storing data that is actually measured after the developer bearing body and the layer thickness regulating member are attached to the developing device, and indicates a characteristic of a developer that has passed between the contacting section and the developer bearing body.

27. A method for remanufacturing a developing device comprising:
a step of refilling with a developer a developing device provided with a developer bearing body for bearing a developer, and a layer thickness regulating member, for regulating a layer thickness of a developer borne on the developer bearing body, that contacts the developer bearing body at a contacting section, and in which surface roughness information indicating surface roughness of the developer bearing body is stored;
a step of obtaining a surface roughness value of the developer bearing body provided in the developing device when refilling with a developer; and
a step of modifying a relative position of the layer thickness regulating member with respect to the developer bearing body, based on the value obtained and the surface roughness information.

28. A method for remanufacturing a developing device according to claim 27,
wherein in the step of obtaining the value,
the surface roughness value is obtained by measuring surface roughness of the developer bearing body provided in the developing device when refilling with a developer.

29. A method for remanufacturing a developing device comprising:
a step of refilling with a developer a developing device provided with a developer bearing body for bearing a developer and a layer thickness regulating member, for regulating a layer thickness of a developer borne on the developer bearing body, that contacts the developer bearing body at a contacting section, in which developer information that specifies the developer is stored;
a step of obtaining second developer information that specifies a developer used for refilling; and
a step of modifying a relative position of the layer thickness regulating member with respect to the developer bearing body, based on the developer information stored in the developing device and the second developer information obtained.

30. A method for remanufacturing a developing device according to claim 27,
wherein relative position information that indicates a relative position before the relative position is modified is stored in the developing device, and
wherein in the step of modifying the relative position,
the relative position is modified using the relative position information.

31. A method for remanufacturing a developing device according to claim 30,
wherein the relative position information is information that indicates a length from the front end of the layer thickness regulating member to the contacting section, and
wherein in the step of modifying the relative position,
the length is modified using the information indicating the length.

32. A method for remanufacturing a developing device according to claim 30,
wherein the layer thickness regulating member has a contacting member that contacts the developer bearing body and a supporting member for supporting at its one end portion the contacting member,
wherein the relative position information is information that indicates a distance from a reference position to the other end portion of the supporting member in a direction from the contacting member toward the developer bearing body, and
wherein in the step of modifying the relative position,
the distance is modified using the information indicating the distance.

33. A method for remanufacturing a developing device comprising:
a step of refilling with a developer a developing device provided with a developer bearing body for bearing a developer in which surface roughness information indicating surface roughness of the developer bearing body is stored; and
a step of obtaining a surface roughness value of the developer bearing body provided in the developing device when refilling with a developer,
wherein in the step of refilling with the developer,
a developer selected based on the value obtained and the surface roughness information is used for refilling.

34. A method for remanufacturing a developing device according to claim 33,
wherein in the step of obtaining the value,
the surface roughness value is obtained by measuring surface roughness of the developer bearing body provided in the developing device when refilling with a developer.

35. A method for remanufacturing a developing device according to claim 33,
wherein developer information that specifies a developer that has been filled in the developing device before being refilled with a developer is stored in the developing device, and
wherein in the step of refilling with the developer,
the developer for refilling the developing device is selected using the developer information.

36. A method for remanufacturing a developing device comprising:
a step of refilling with a developer a developing device provided with a developer bearing body for bearing a developer in which developer information that specifies the developer is stored;
a step of obtaining second developer information that specifies a developer used for refilling; and
a step of replacing the developer bearing body with another developer bearing body selected from among a plurality of developer bearing bodies that mutually have different surface roughness based on the developer information stored in the developing device and the second developer information obtained.

37. A method for remanufacturing a developing device according to claim 36,
wherein surface roughness information that indicates surface roughness of a developer bearing body that has been provided in the developing device before replacement of the developer bearing body, that is surface roughness when the developer bearing body has been attached to the developing device, is stored in the developing device, and
wherein in the step of replacing the developer bearing body with the another developer bearing body,
the another developer bearing body is selected from among a plurality of developer bearing bodies that mutually have different surface roughness using the surface roughness information.

38. A method for remanufacturing a developing device comprising:
a step of refilling with a developer a developing device provided with a developer bearing body for bearing a developer, a layer thickness regulating member, for regulating a layer thickness of a developer borne on the developer bearing body, that contacts the developer bearing body at a contacting section, and in which surface roughness information indicating surface roughness of the developer bearing body is stored;
a step of obtaining a surface roughness value of the developer bearing body provided in the developing device when refilling with a developer; and
a step of modifying a relative position of the layer thickness regulating member with respect to the developer bearing body, based on the value obtained and the surface roughness information,
wherein
in the step of obtaining the value,
the surface roughness value is obtained by measuring surface roughness of the developer bearing body provided in the developing device when refilling with a developer,
relative position information that indicates the relative position before the relative position is modified is stored in the developing device,
in the step of modifying the relative position,
the relative position is modified using the relative position information,
the relative position information is information that indicates a length from a front end of the layer thickness regulating member to the contacting section,
in the step of modifying the relative position,
the length is modified using the information indicating the length,
the layer thickness regulating member has a contacting member that contacts the developer bearing body and a supporting member for supporting at its one end portion the contacting member,
the relative position information is information that indicates a distance from a reference position to the other end portion of the supporting member, in a direction from the contacting member toward the developer bearing body, and
in the step of modifying the relative position, the distance is modified using the information indicating the distance.
